(19) United States
(12) Patent Application Publication
(10) Pub. No.: US 2006/0187806 A1
(43) Pub. Date: Aug. 24, 2006

(54) Optical information carrier comprising thermochromic or photochromic material

(75) Inventors: Marcello Leonardo Mario Balistreri, Eindhoven (NL); Andrei Mijiritskii, Eindhoven (NL); Johannes Theodorus Adriaan Wilderbeek, Eindhoven (NL); Christopher Busch, Eindhoven (NL); Bin Yin, Eindhoven (NL); Hubert Cecile Francois Martens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/548,939

(22) PCT Filed: Mar. 17, 2004
(86) PCT No.: PCT/IB04/50266

§ 371 Date: Sep. 12, 2005

(30) Foreign Application Priority Data
Mar. 18, 2003 (EP) 03100694.3
Jul. 15, 2003 (EP) 03102150.4

(51) Int. Cl. G11B 7/24

(52) U.S. Cl. 369/275.1; 369/283

(57) ABSTRACT

The present invention relates to an optical information carrier for recording information by means of an optical beam, said optical information carrier comprising a substrate layer (S), a recording layer (P) including a thermochromic material having temperature-dependent optical characteristics or a photochromic material having light dependent optical characteristics for selectively improving the sensitivity during recording and/or read-out, and a cover layer (C). To achieve an increase reflectivity the recording layer (P) at elevated temperature or high light intensity, respectively, and a very high transmission and low reflectivity at ambient temperature or low light intensity, respectively, it is proposed to use a thermochromic or photochromic material that has an imaginary part k of the complex refractive index ñ being larger than 0 at elevated temperature or high light intensity, respectively. The present invention relates also to a method of determining the thickness of a recording layer of such an optical information carrier and to a read-out device for reading data from such an optical information carrier.

The present invention relates to an optical information carrier for recording information by means of an optical beam, said optical information carrier comprising

a substrate layer,

a recording layer including a thermochromic material having temperature-dependent optical characteristics or a photochromic material having light-dependent optical characteristics for selectively improving the sensitivity during recording and/or read-out, and a cover layer.

The invention relates further to a method of determining the thickness of a recording layer (P) of such an optical information carrier and to a read-out device for reading data from such an optical information carrier.

The use of the thermochromic effect for enhanced reading and writing in a multi-stack optical information carrier is described in European patent application 02078676.0 (PHNL 020794 EPP). In order to achieve that one of many recording layers can be effectively addressed for writing/reading of data without much interaction with the non-addressed recording layers the recording layers include a thermochromic material having temperature-dependent optical characteristics for selectively improving the sensitivity of the addressed recording layer during recording and/or read-out. Further, the implementation of the thermochromic effect for a reflective ROM and WORM multilayer system with an effective reflectivity of 3.6% is described therein.

A number of different reversible organic and anorganic thermochromic materials are available. Many different materials have also been described in the above mentioned European patent application 02078676.0 (PHNL 020794 EPP), such as pi-conjugated oligomers or polymers of pi-conjugated materials in a polymer matrix, pH sensitive dye molecules and color developers, polar host materials, polymer materials in which spiropyrans, spirobichromenes or spirooxazines are comprised, polymer materials in which sterically hindered photochromic dyes are comprised, polymer materials in which thermochromic dyes, in particular cyanine or phthalocyanine dyes, are comprised, and dye materials in which the dye molecules are aggregated, in particular forming J-type aggregates or H-type aggregates. Thermochromic materials are also described in U.S. Pat. No. 5,817,389, such as polyacene class, phthalocyanine class, spiropyran dye, lactone dye, and fluoran dye.

The aim of the thermochromic effect is to absorb as little as possible light at the out-of-focus layer(s) at ambient temperatures, but sufficient to initiate the thermochromic effect in the in-focus layer and to reflect as much as possible at elevated temperatures. However, although a number of thermochromic materials are available, the best candidate fulfilling these requirements for a single- or multilayer optical information carrier has to be selected.

Also a number of photochromic materials are known from U.S. Pat. No. 5,817,389, such as xanthene dye, azo dye, cyanin dye and others. The aim of the photochromic (PC) effect is to change the optical constants (n and k) in a similar way as for thermochromic (TC) materials by increasing the light intensity and not by increasing the temperature. Thus, an identical spectral shift of n and k occurs for both the PC and TC materials, but only based on another principle. By use of a photochromic material one can thus make use of the non-linear optical properties of the materials, meaning that the optical constants (n and k) vary with the intensity of the incident light so that these materials have light-dependent optical characteristics. Photochromic materials are known for reversibility or irreversibility, depending on the conditions. Temperature stability is generally not of a major concern within the limits typical for organic materials. Initial investigations of the speed and stability of photochromic materials indicate that the intrinsic speed or response time of these materials is fast (˜ns or faster), substantially faster than thermochromic materials. But also from the available photochromic materials, the best candidate fulfilling the desired requirements for a single- or multilayer optical information carrier has to be selected.

The reflectivity of the known recording layer comprising thermochromic or photochromic material is low, around 3%, and is even less than the effective reflectivity of a dual-layer BD disk. Such a low reflectivity poses problems for the drive since it results in a low light intensity from which for instance the focus and tracking signals, or the HF signal are derived. Ultimately, a low number of photons limits the achievable data-rate (photon shot noise versus detector bandwidth).

It is therefore an object of the present invention to provide an optical information carrier having one or more recording layers, which have an increased reflectivity in the in-focus state and a very high transmission but negligible reflectivity in the out-of-focus state. It is a further object of the invention to provide a method of determining the thickness of a recording layer of an optical information carrier in order to find an optimized thickness providing maximal contrast (˜100%) and maximal transmission for a given initial absorption if a refractive index mismatch would occur in the written marks after writing. It is a still further object of the invention to provide a read-out device for reading data from such an optical information carrier by which the read-out temperature can be kept below the threshold writing temperature in order to avoid a writing effect during read-out.

This object is achieved according to the present invention by an optical information carrier as claimed in claim 1 which is characterized in that the thermochromic or photochromic material has an imaginary part k of the complex refractive index ñ being larger than 0 at elevated temperature or high light intensity, respectively.

It is known that the thermochromic or photochromic material has an index of refraction that should be closely matched at ambient temperature or low light intensity, respectively, to the index of refraction of the substrate material. Therefore no or very little reflection will occur at the substrate-recording layer interface. The material does show some limited absorption at ambient temperature or low light intensity that is enough to initiate the self-amplifying thermochromic or photochromic effect at the focus. The TC-effect is self-amplifying, but the PC-effect is in principle not In the case of the PC-effect the illuminated PC-molecule transfers from state A to state B without intermediate states. However, a non-linear PC-effect could be feasible using the temperature dependence of the refractive index of the PC material or the temperature depence of the transfer rate from state A to B together with the optical PC-effect. It has been further recognized that at the focus, due to the self-amplifying effect, not only the absorption profile k (imaginary part of the complex refractive index ñ) shifts, but according to the Kramers-Kronig relation also the real part of the refractive index (often simply called the refractive index n).

Typical dyes considered at present for blue wavelength recording have refractive index nvalues between 1 and 3 and k values between 0 and 1.5 (depending on the selected material and the used laser wavelength). However, it is even possible to use organic materials having values for n and k in the range 1<=n<=4 and 0<k<=3 and inorganic materials having values 0<n<=4 and 0<k<=5. These dyes have not yet been studied for thermochromic or photochromic effects but the n and k range for organic TC-materials will be similar. Using a refractive index n_{FPC} of 1.6 for a standard polycarbonate substrate material leads to a peak interface-reflectivity between dye and polycarbonate of approximately

$$R = {( \frac{{n}_{DF} - {n}_{PC}}{{n}_{DF} + {n}_{PC}} )}^{2} = 2.5` \% .$$

Based on these recognitions the present invention uses constructive interference inside the thermochromic or photochromic recording layer in order to obtain a significant increase of the effective reflectivity, preferably >>5%, of the in-focus layer, in particular for a multilayer system having at least two recording layers, with almost 100% transparency and negligible reflectivity of the out-of-focus layer(s). Thus, the invention is based on the idea that also an increase of the imaginary part k of the refractive index ñ, alone or simultaneously to a change of the real part n of the refractive index ñ, can lead to an increased reflectivity at the in-focus state. For instance, in the case of a dual layer RW BD disk an optimized four-layer stack design per recording layer has been used to obtain a reflectivity of ˜20% of the second (deepest) recording layer. However, an effective reflectivity of only ˜5% for this second layer is obtained because the transmission of the first layer is ˜50%, both for the incident and the light reflected from the second layer.

Further, it has been found that an additional thermo- or photochromic resolution enhancement factor can be obtained by taken also the influence of the imaginary part k on the resolution into account and by selecting k as proposed by this invention.

Still further, it has been found that by using the non-linear effect of thermo- or photochromic materials less aberrations for an absorbing or reflective optical storage system can be obtained. In the case of DVD using a blue laser diode the non-linear effect can be used to increase the tilt margins. In the case of multilayer storage it can be used to increase the depth range. In all single- and multilayer applications the non-linear effect can be used to increase the numerical aperture of the objective while keeping the aberrations at an acceptable level.

The conventional reflective optical storage systems, e.g. CD, DVD, and BD, are based on a phase grating which requires an accurate depth of the pits/grooves. A small deviation from the optimal depth results in a decrease of the signal contrast and in turn the signal-to-noise ratio (SNR). It has also been found that the reflectivity and the contrast of a reflective storage system can be made independent of the pit/groove depth by optimizing the real part n and the imaginary part k of the refractive index of thermo- or photochromic materials as proposed according to the present invention.

Elevated temperature or high light intensity, respectively, here mean a temperature/light intensity significantly above ambient temperature/a threshold light intensity. An elevated temperature/high light intensity is produced during recording by focusing a recording laser beam onto the recording layer or, in case of several recording layers, onto a particular recording layer, i.e. the temperature/light intensity of an in-focus recording layer is much higher than an out-of-focus recording layer. Elevated temperatures typically lie in the range of 100-800° C. (the temperature should at least be higher than the operation temperature of the drive, e.g. 60-80° C. in a car. A high light intensity typically lies in the range of 0.5-300 MW/cm², e.g. current intensity of the blue laser diode produced by Nichia in combination with 0.85 NA objective is 0-8 MW/cm², and up to 150 MW/cm² for the picosecond pulsed laser produced by Picoquant.

High light intensities can be obtained with different small pulsed laser systems in combination with a BD-lens (405 nm and 0.85 NA):

1. 8 MW/cm² for the blue Nichia laser with ˜35 pJ pulse energy and ˜10 ns pulse duration;

2. 300 MW/cm² for the PicoQuant laser with ˜10 pJ pulse energy and ˜70 ps pulse duration.

Preferred embodiments of the invention are defined in the dependent claims.

According to a preferred embodiment the thermochromic or photochromic material has an imaginary part k being larger than 0.5, and preferable larger than 1, above threshold. In this range a high reflectivity increase can be obtained, in particular if simultaneously the real part n also decreases above threshold.

In order to avoid reflection at borders between layers at ambient temperature, the refractive index of the thermochromic or photochromic material at ambient temperature is advantageously matched to the refractive index n of the substrate and preferably, in case of a multilayer disk comprising more than one recording layer separated by spacer layers, also to the refractive index n of the spacer layers.

Further, according one embodiment, the refractive index n of the thermochromic material matches the refractive index n of the substrate and possible spacer layers at elevated temperatures, while according to another embodiment the refractive index n of the thermochromic or photochromic material is higher than the refractive index n of the substrate and possible spacer layers at elevated temperatures. In the latter embodiment, the k value of the thermochromic or photochromic material is preferably selected to be equal to or larger than 0.5, while in the first embodiment already a k value above zero leads to an increase of the reflectivity.

According to another embodiment of the invention, the refractive index n of the thermochromic or photochromic material is not increased at elevated temperature but decreased since it has been found that by a decrease the refractive index n an even further increase of the reflectivity can be obtained compared to an increase of the refractive index n. In particular, a refractive index n in the range from 1.0 to 1.6 at elevated temperature is advantageous. For instance, the reflectivity can become up to 30% for a refractive index n of 1.0 and a k value of about 1.5.

It has been further realized that also the thickness of a recording layer can have an influence on the reflectivity at elevated temperature. A preferred thickness range is in the range from 10 to 200 nm, in particular in the range from 20 to 80 nm. The optimal thickness for the recording layer depends mainly on the value of the real part n of the refractive index, in particular on the difference between the real part n of the refractive index for the recording layer and the real part n of the adjacent substrate layer or an adjacent spacer layer. Further, the wavelength used for read-out or recording has an influence on the optimal thickness of the recording layer.

It was further found that the reflectivity can be further enhanced at the expense of an increased media complexity using dielectric layers around the recording layer. At least one dielectric layer is positioned on each side of the recording layer in a preferred embodiment. Advantageously a five-layer design, where two dielectric layers are positioned on each side of a recording layer is proposed, by which a reflectivity of up to 55% can be obtained. Preferred selections of the refractive index n of the dielectric layers as well as preferred materials for use as dielectric material are defined in claims 8 to 10.

According to the present invention the thermochromic or photochromic material can at the same time be the recording material, but it is also possible that an additional recording material is present in the recording layers. Preferably the invention is applied in ROM or WORM (write once read many) optical disks such as CD-ROM, CD-R, DVD-ROM or BD (Blue ray disk) having one or more recording layers.

The present invention also relates to a method of determining the thickness of a recording layer (P) of an optical information carrier according to the invention, said method comprising the steps of.

selecting a thermochromic or photochromic material having a low initial k value (kᵢₙᵢₜᵢₐₗ) at a first wavelength and a higher k value at a second wavelength shorter or longer than said first wavelength, and having a real part n of the complex refractive index fi matched to that of substrate layer and/or said cover layer,

recording test data,

determining the refractive index mismatch Δn between said thermochromic or photochromic material and said substrate layer and/or said cover layer at essentially said first wavelength after recording said test data,

determining the smallest optimized layer thickness of said thermochromic or photochromic material by determining the signal-contrast between a written and an unwritten mark,

determining the maximal initial k value at essentially said first wavelength for said optimized layer thickness before recording.

By this method the signal-contrast of the in-focus layer and the transmission of the out-of-focus layers in a multi-layer record carrier is optimized if a refractive index mismatch Δn would occur in the written marks after recording. For every refractive index mismatch Δn an optimized layer thickness can be found with maximal contrast (˜100%) and maximal transmission for a given initial absorption, without scarifying the signal-strength. Preferred embodiments of this method are defined in dependent claims.

The present invention further related to a read-out device for reading data from an optical information carrier as claimed in claim 16 comprising:

a light source for emitting a reading light beam,

a multi-spots grating for generating at least two displaced light beams from said reading light beam,

means for focusing the displaced light beams on different positions on the information carrier and for focusing reflected light beams on different position on a detector, and

a detector for receiving said reflected light beams.

Preferably a 2-spots, 4-spots, 8-spots or 10-spots grating is used so that 2, 4, 8 or 10 bits can be read simultaneously.

By use of the record carrier as proposed according to the present invention the temperature in the disk could increase above the writing threshold temperature during read-out, because of the high absorption using high k values. This would result in a writing effect during read-out. By use of a multi-spots grating as proposed according to the present invention the read-out laser power on the disk can be reduced and the read-out temperature can be kept below the threshold writing temperature. An additional advantage of the multi-track approach is the increase of the total data rate, despite the lower read-out power per spot, compared to the conventional single layer DVD+RW phase change system.

The invention will now be explained in more detail with reference to the drawings in which

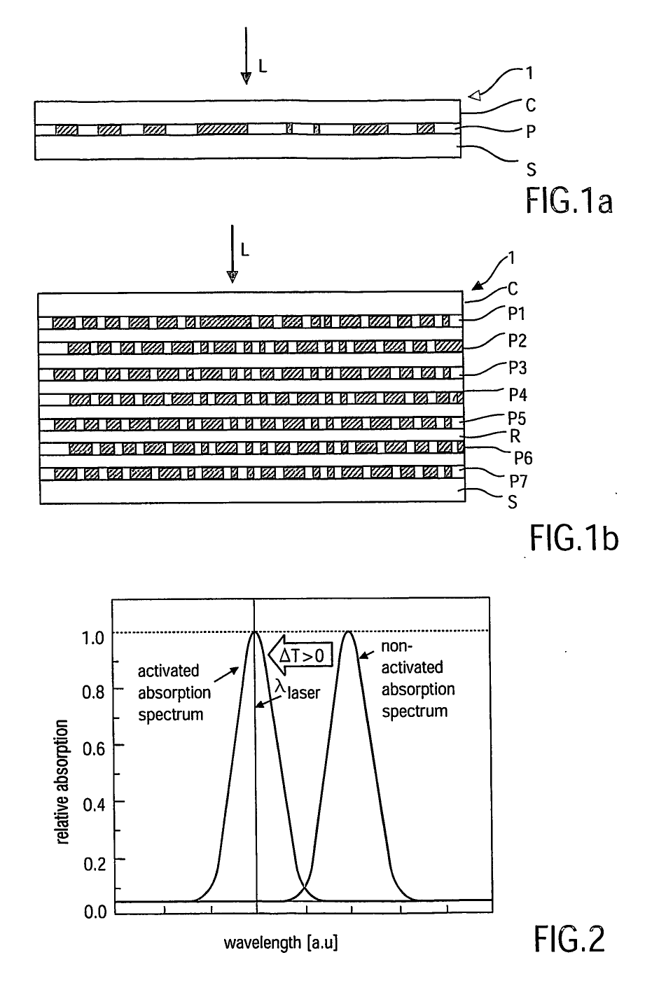

FIGS. 1a, b show a cross-section of a single-layer and a multilayer optical information carrier according to the present invention,

FIG. 2 illustrates the principle of increased absorption,

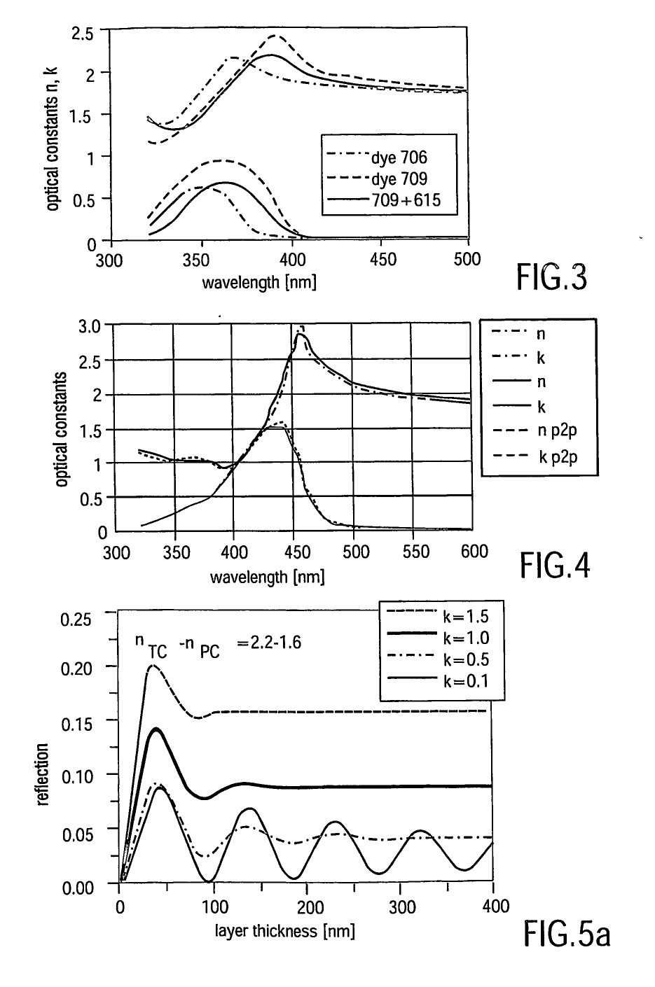

FIGS. 3, 4 show measured real (n) and imaginary (k) parts of the complex refractive index (ñ) of organic dyes as function of the wavelength,

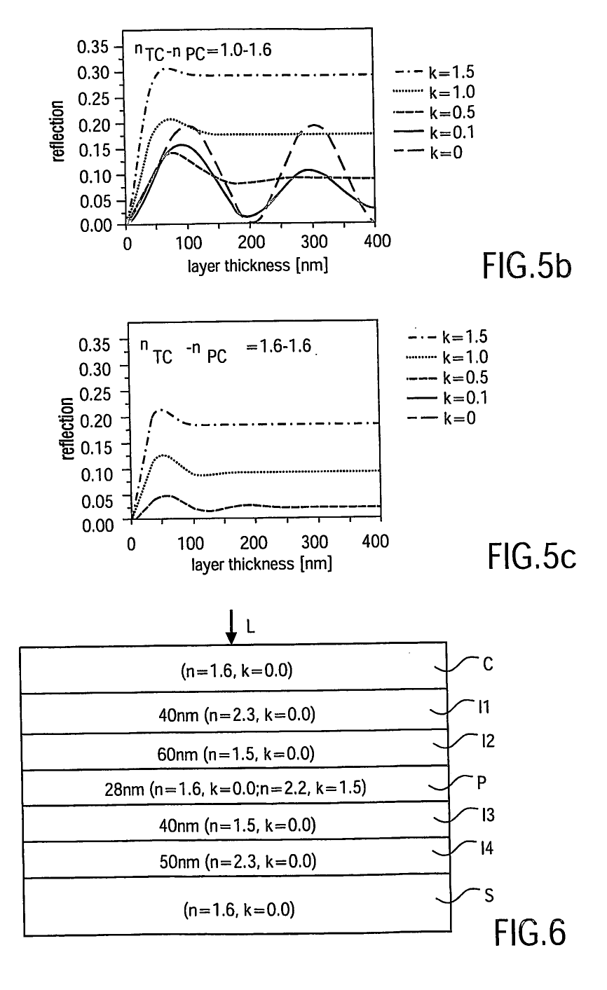

FIG. 5 shows the reflectivity of a thermochromic layer as function of the layer thickness for different k values,

FIG. 6 shows a cross-section of a single-stack optical information carrier according to the present invention comprising one recording layer and four dielectric layers,

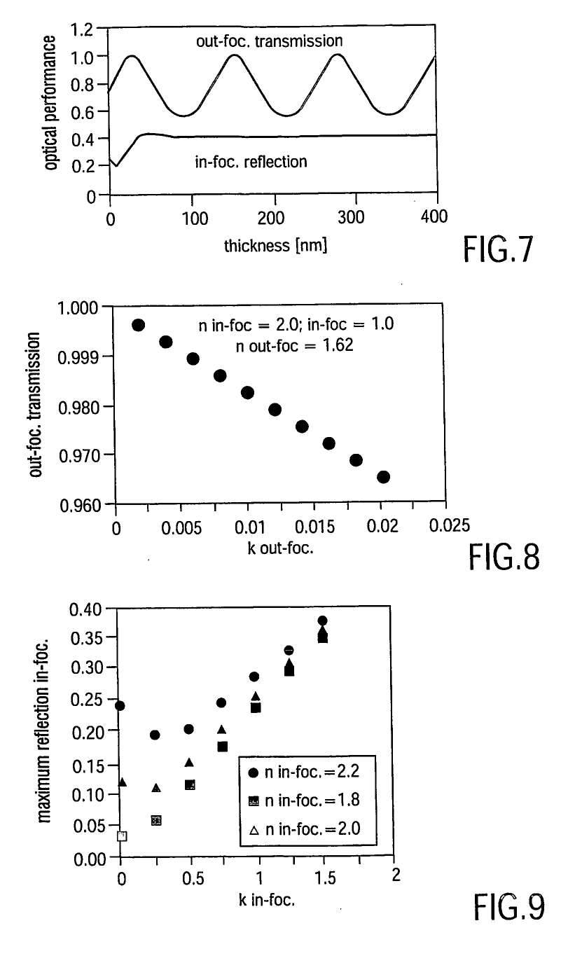

FIG. 7 shows the in-focus reflection and the out-of-focus transmission as function of the recording layer thickness for the information carrier shown in FIG. 6,

FIG. 8 shows the out-of-focus transmission as function of the k value for the information carrier shown in FIG. 6,

FIG. 9 shows the in-focus reflection of a thermochromic layer as function of the k value for the information carrier shown in FIG. 6,

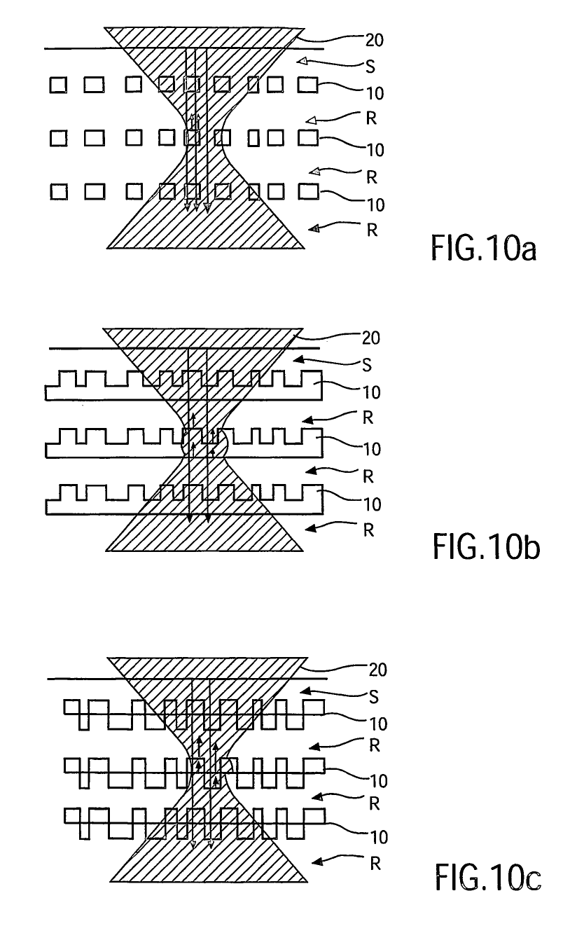

FIG. 10 shows side views of an implementation of a thermochromic ROM carrier where the thermochromic material shows a temperature-dependent reflection characteristic,

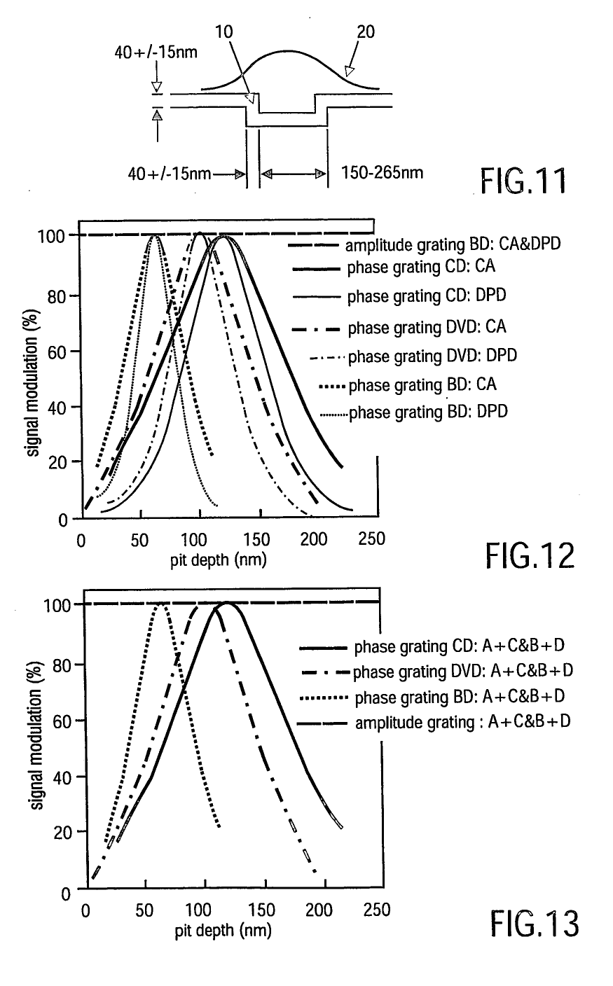

FIG. 11 shows a practical implementation of the carrier shown in FIG. 10c,

FIG. 12 shows the signal contrast versus pit depth for a central aperture and a DPD tracking signal,

FIG. 13 shows the signal contrast versus pit depth for signals A+C and B+D for DTD2 tracking,

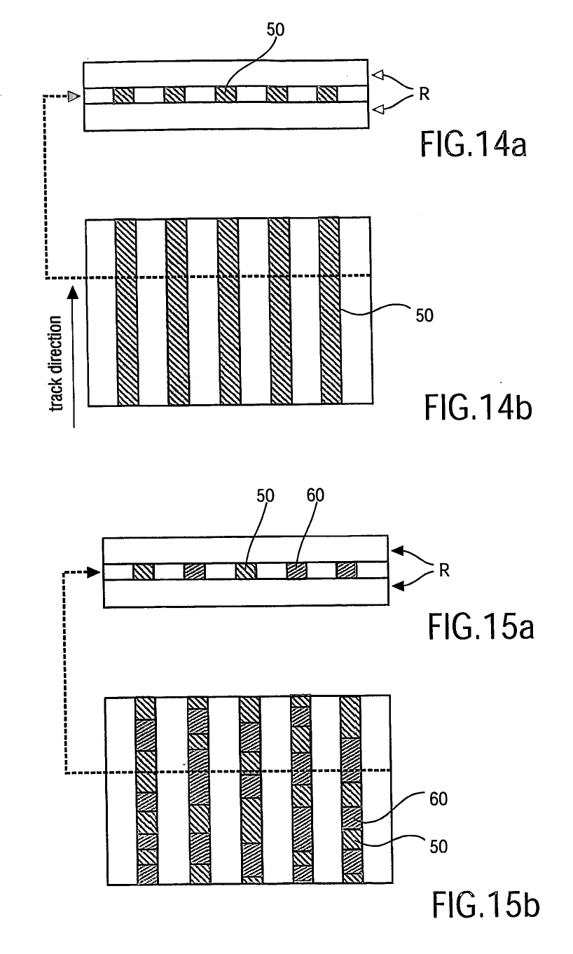

FIG. 14 shows the concept of a WORM implementation with unwritten tracks,

FIG. 15 shows the WORM implementation of FIG. 14 with written tracks,

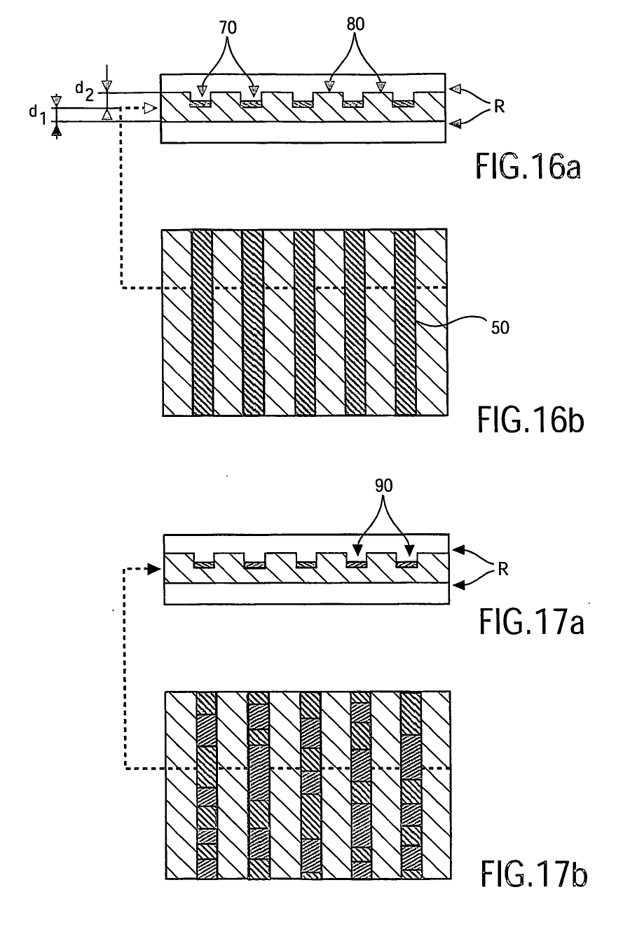

FIG. 16 shows the concept of another WORM implementation with unwritten tracks,

FIG. 17 shows the WORM implementation of FIG. 16 with written tracks,

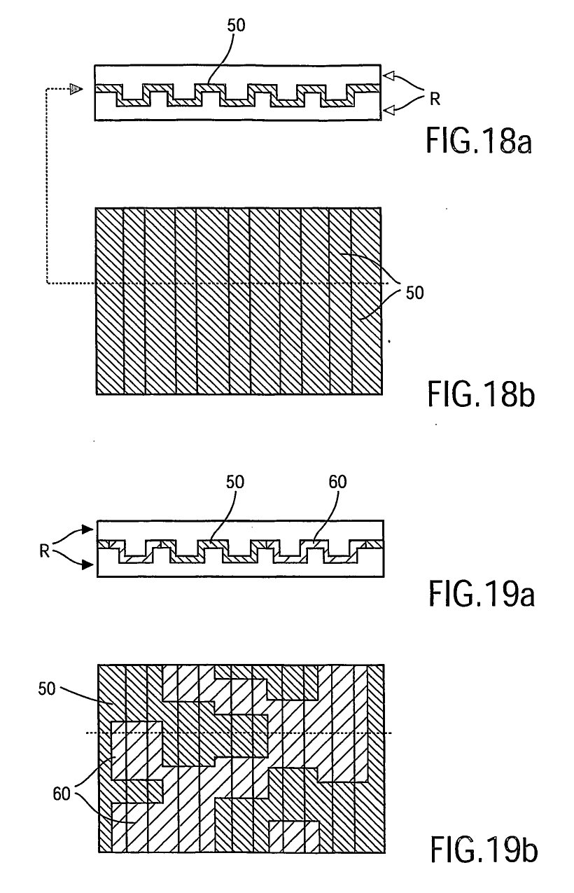

FIG. 18 shows the concept of a third WORM implementation with unwritten tracks,

FIG. 19 shows the WORM implementation of FIG. 18 with written tracks,

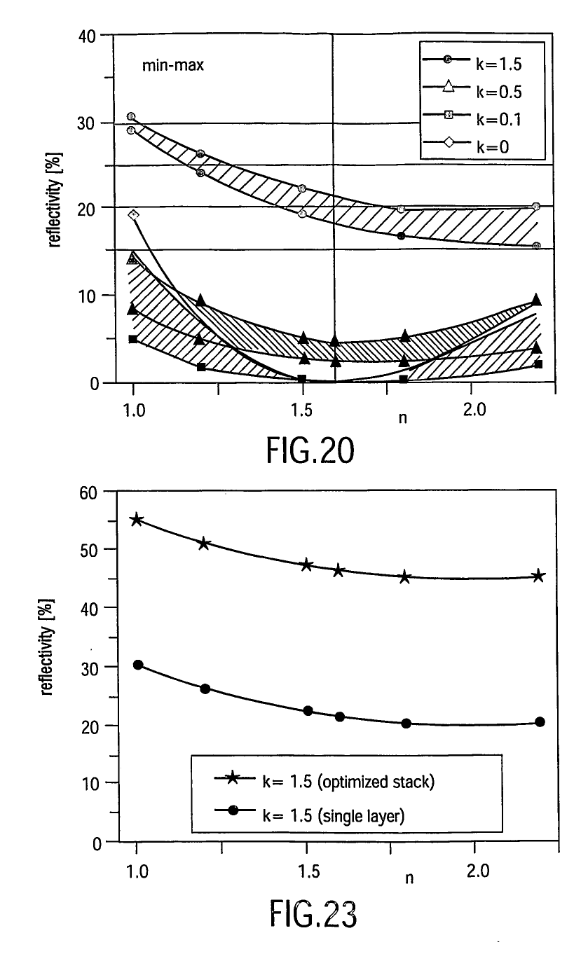

FIG. 20 shows the reflectivity as a function of n and k,

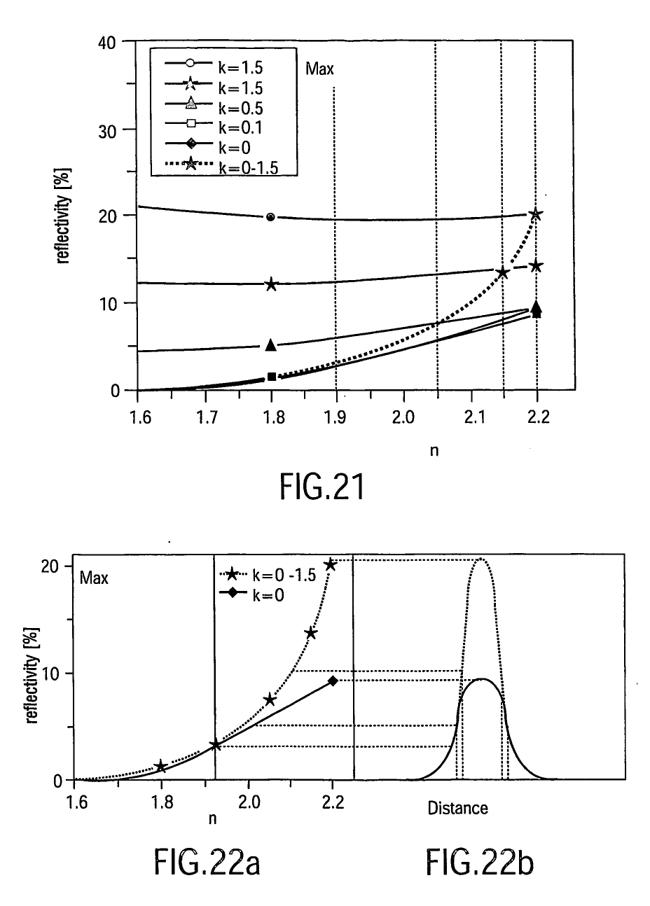

FIG. 21 shows the reflectivity when n and k are simultaneously changed,

FIG. 22 shows the reflectivity as a function of n and of the distance for k=0 and k=0-1.5,

FIG. 23 shows the maximum reflectivity as a function of n for k=1.5 for different record carrier stacks,

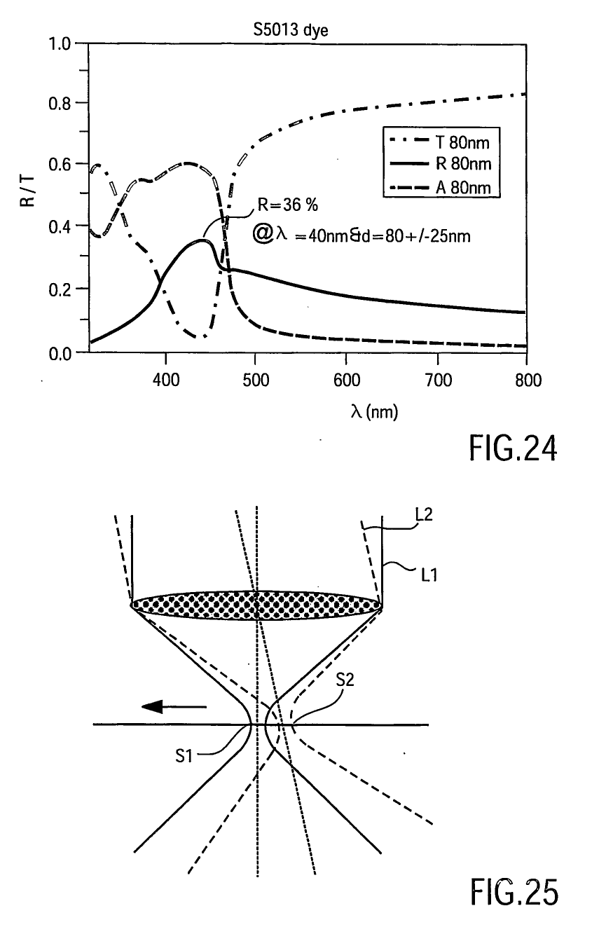

FIG. 24 shows the measured reflectivity, transmission and absorption over wavelength for a S5013 dye material,

FIG. 25 shows an optical implementation using a photochromic material,

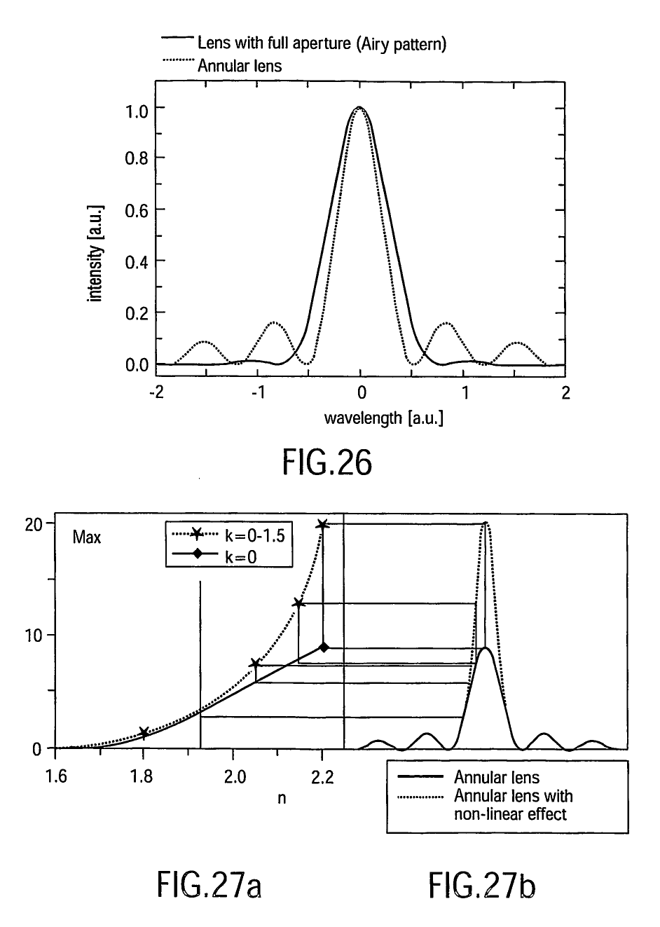

FIG. 26 shows the intensity distributions of a spot of a lens with a full and an annular aperture,

FIG. 27 shows the reflectivity as a function of n and of the distance for k=0 and k=0-1.5 along the spot of an annular lens,

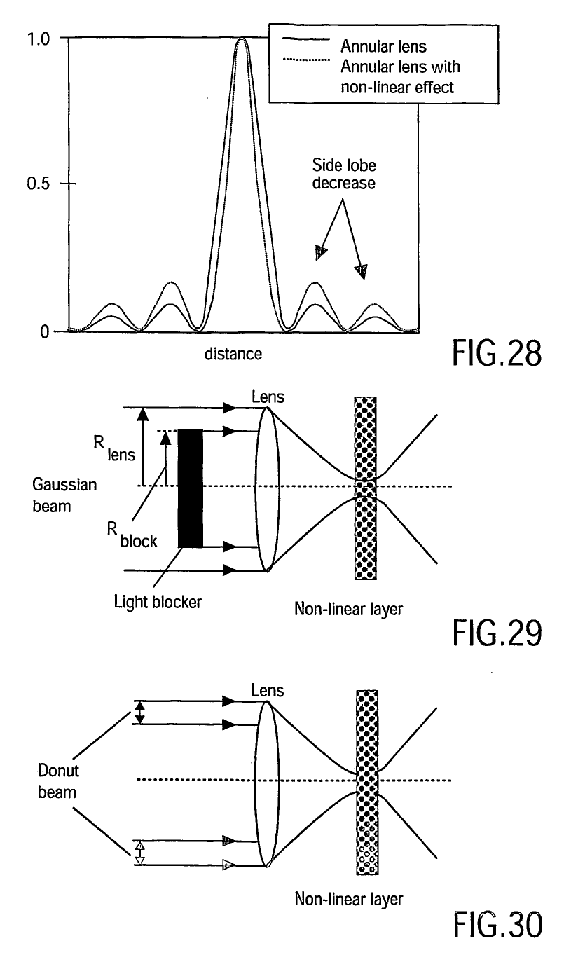

FIG. 28 shows normalized reflectivity profiles shown in FIG. 27,

FIG. 29 shows an first embodiment of a recording optics using a central light blocker,

FIG. 30 shows an second embodiment of a recording optics using beam shaping optics,

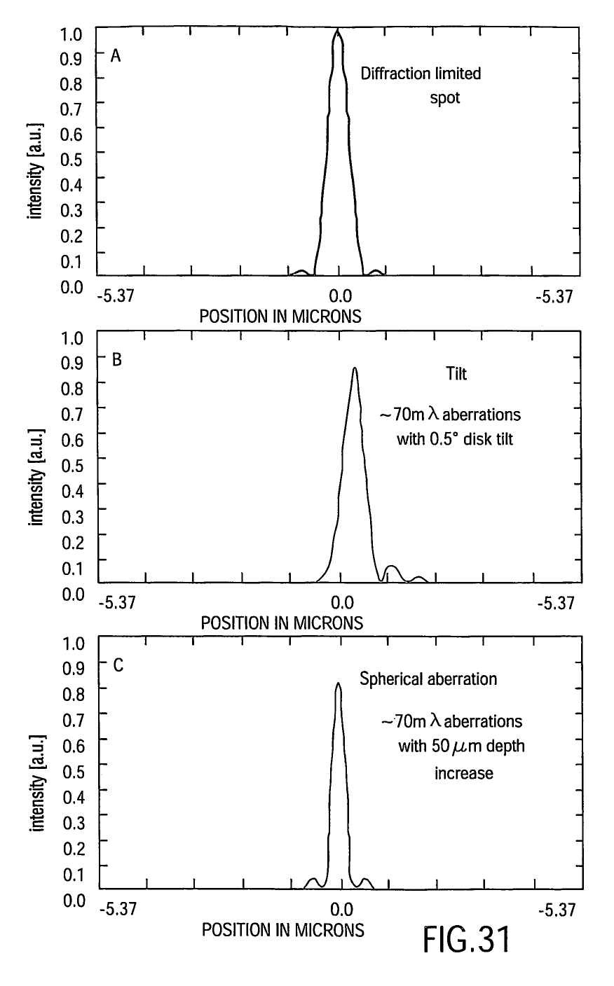

FIG. 31 shows the intensity transfer from the central spot to side lobes due to disk tilt or spherical aberration,

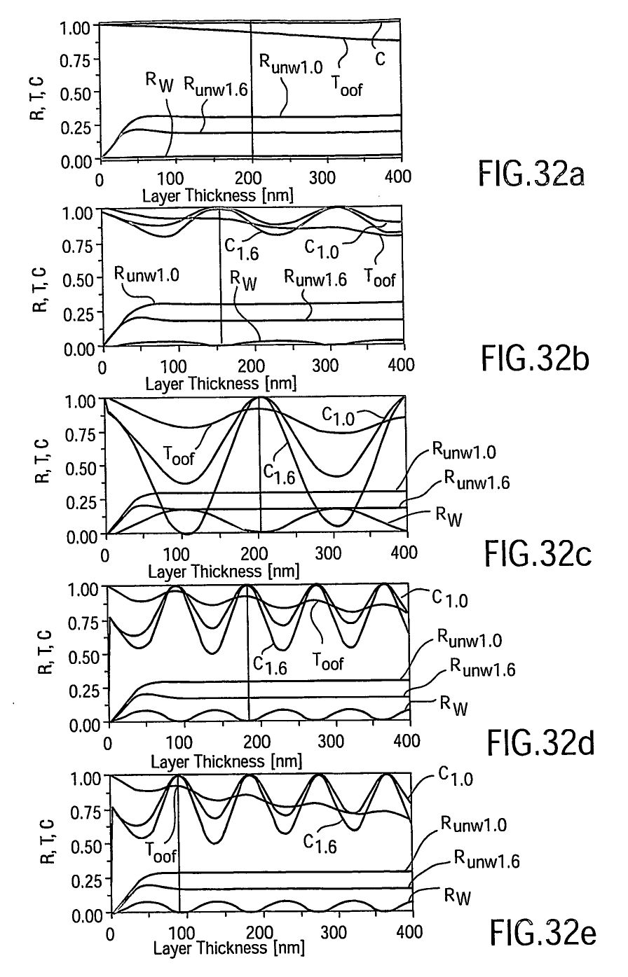

FIG. 32 the reflection, transmission, absorption, and signal contrast of a single layer thermo-/photochromic recording stack in- and out-of-focus before (unwritten mark) and after writing (written mark) for different cases,

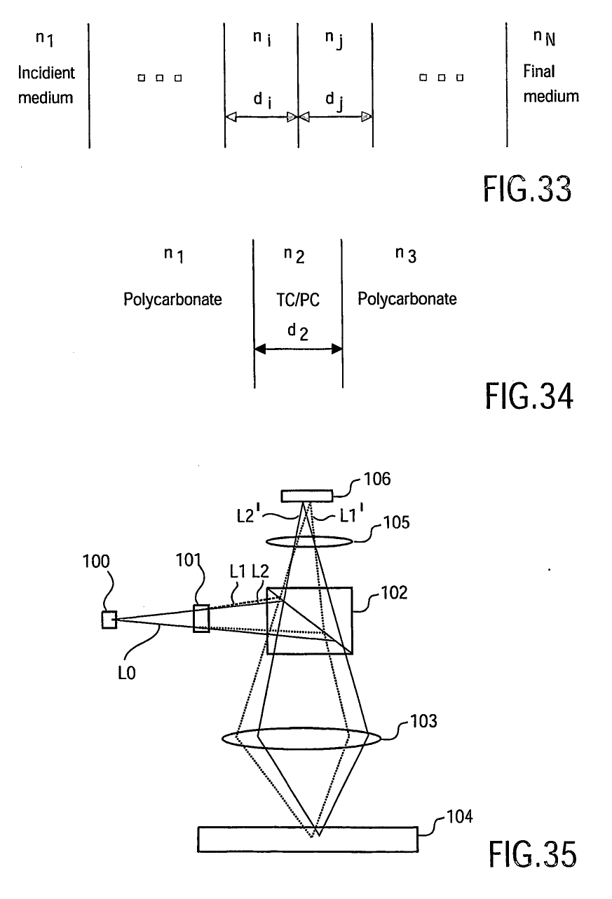

FIG. 33 illustrates the notation for a matrix method of multiple-reflection, multiple-medium optics,

FIG. 34 shows an embodiment of a stack design used for the calculation of the the total reflection, transmission and absorption in the TC/PC layer in between two polycarbonate (PC) spacer layers at 405 nm, and

FIG. 35 shows an embodiment of a read-out device according to the present invention comprising a 2-spot grating.

FIG. 1a shows an embodiment of a single-layer optical information carrier according to the present invention. On top of the carrier 1 a cover layer C for protection is provided, onto which an optical beam L, such as a laser beam or light generated by LEDs, is incident. Thereafter a single recording layer P is provided. Below the recording layer P a substrate S, e.g. of polycarbonate, is provided.

FIG. 1b shows an embodiment of a multi-stack optical information carrier 1 according to the present invention. Instead of only a single recording layer P, a number of recording stacks are provided each comprising one recording layer P1 to P7. The recording stacks, and thus also the recording layers P1 to P7, are separated by spacer layers R to optically and thermally separate adjacent recording layers.

The information carrier according to the embodiment of FIG. 1b is thus formed by an alternating stack of inert passive spacer layers R and active recording layers P1 to P7. The spacer layers R are optically inactive and transparent and have a thickness of preferably between 1 and 100 μm, in particular between 5 and 30 μm. The recording layers P1 to P7 have a thickness of preferably between 0.05 and 5 μm.

Besides the recording and information carrying functionality, a thermochromic (or, alternatively, a photochromic) functionality is provided in the recording layers P to provide a temporary reversible effect of increasing the interaction of the incoming light with the addressed recording layer. Depending on the implementation, the change in the imaginary and/or the real part of the refractive index leads to a change in the absorption, reflection and transmission characteristics which is then used for read-out. These functionalities are preferably combined in one material but can also be separated in different materials.

Since in all but the addressed recording layers the light intensity is low the thermal profile stays either below a threshold temperature such that no change in the absorption profile happens at all, a change meaning a spectral shift or a change in form, or that the change is not large enough to introduce an increase in absorptivity at the desired wavelength, e.g. a spectral shift of the profile towards the laser wavelength which might be linear in temperature but without the higher absorption part of the spectrum reaching it. Therefore, only in the addressed recording layer an increase in temperature is achieved that is significant enough to locally (i.e. at the position of the focus) increase the absorptivity at the desired wavelength. In case of PC-materials an intensity threshold is used. In case of PC materials, a substantial local increase in reflection and/or absorption (?) of the addressed layer is obtained due to the high light intensity in the focal point No substantial increase in reflection and/or absorption is obtained in the other layers due to the lower light intensity.

The refractive index of recording layers and spacer layers should be matched for the temperatures encountered in the out-of-focus layers to minimize reflections at the interfaces.

The effect of the present invention is illustrated in FIG. 2. At ambient temperature, the relative absorption at the laser wavelength laser is small. Therefore, all out-of-focus recording layers are almost transparent to the incident light. Only at the addressed recording layer the intensity of the laser is high enough to heat up the material sufficiently to change the optical properties significantly, thereby further increasing the temperature and the localized heating.

The reflectivity of a thermochromic recording layer is low (around 3%) and is even less than the effective reflectivity of a dual-layer BD disk. Such a low reflectivity poses problems for the drive since it results in a low light intensity from which for instance the focus and tracking signals, or the HF signal are derived. Ultimately, a low number of photons limits the achievable data-rate (photon shot noise versus detector band width).

The thermochromic material has an index of refraction that should be closely matched at ambient temperature to the index of refraction of the substrate material. Therefore no reflection will occur at the substrate-recording layer interface. The material does show some limited absorption at ambient temperature that is enough to initiate the self-amplifying thermochromic/photochromic effect at the focus. At the focus, due to the self-amplifying effect, not only the absorption profile (imaginary part k of the refractive index ñ) shifts as shown in FIG. 2, but according to the Kramers-Kronig relation also the real part n of the complex refractive index ñ.

Typical dyes considered for blue wavelength recording have refractive index n values between 1 to 3 and k values between 0 and 1.5 (depending on the selected material and the used laser wavelength) which can be seen in FIGS. 3 and 4 where measured real (n) and imaginary (k) parts of the refractive index of organic dyes as function of wavelength are shown. These dyes have not yet been studied for thermochromic effects, but the graphs do show the practical n and k values that can be achieved with “blue” dyes. A refractive index increase from 1.7 up to 2.4 looks feasible from FIG. 3. The imaginary part k also increases up to a value of 0.5. A refractive index increase from 1.9 up to 3.0 looks also feasible with a k value around 1.0 (see FIG. 4). For a refractive index of 2.5 a k value around 1.5 is found in the same figure. Using a refractive index of 1.6 for a standard polycarbonate substrate material leads to a peak interface-reflectivity between dye and polycarbonate of approximately

$$R = {( \frac{{n}_{DF} - {n}_{PC}}{{n}_{DF} + {n}_{PC}} )}^{2} = 2.5` \% .$$

The idea of the present invention is to use constructive interference inside the thermochromic recording layer in order to obtain a significant increase of the effective reflectivity (>>5%) of the in-focus layer for a multilayer carrier (≧2 layers) or of the single recording layer in the embodiment shown in FIG. 1a with almost 100% transparency and negligible reflectivity of the out-of-focus layers. In the case of a dual layer RW BD disk an optimized four-stack design per layer has been used to obtain a reflectivity of ˜20%. However, an effective reflectivity of ˜5% for the second layer is found because the transmission of the first layer is ˜50%, both for the incident and the reflected light. The influence of the increase of the imaginary part alone or simultaneously with a change of the real part of the refractive index due to the thermochromic/photochromic effect is not known (see FIGS. 3 and 4). The aim of the thermochromic/photochromic effect is to absorb as little as possible light (k≈0.002) at the out-of-focus layers at ambient temperatures, but sufficient to initiate the thermochromic effect in the in-focus layer, and to reflect as much as possible at elevated temperatures (k≧0.5).

The exemplary calculations n the following have been performed assuming a laser wavelength of 405 nm. To obtain similar performance at a different laser wavelength λ, the thickness of the separate layers in the proposed stack designs should be scaled by λ/405 (λ in nanometers).

It has been found that using a large refractive index difference due to the thermochromic/photochromic effect in combination with a high k value (k≧0.5) results in a significant reflectivity increase compared to the case with a lower k value (k≈0.1). FIG. 5 shows the calculated reflectivity of a thermochromic layer as function of the k value (0, 0.1, 0.5, 1.0, and 1.5). Different cases for the change of n are shown: from 1.6 to 1.0 (FIG. 5a), from 1.6 to 1.6 (FIG. 5b) and from 1.6 to 2.2 (FIG. 5c).

The refractive index n of the polycarbonate (PC) disk is 1.6 and of the thermochromic material is also 1.6 at ambient temperatures/low light intensities and 2.2 at elevated temperatures/high light intensities. The reflectivity is strongly dependent on the layer thickness for low k values (≈0.1). The oscillation as function of the layer thickness should be noted. A maximal reflectivity of 8.6% is found for a layer thickness of 45 nm and a minimal reflection of 0.2% for a thickness of 90 nm. For the same refractive index variation and a higher k value (≧0.5) a further increase of the reflectivity is found. A maximal reflectivity of 9.2%, 13.9%, and 20.1% has been found for a layer thickness of ≈40 nm for k is 0.5, 1.0, and 1.5, respectively. The reflectivity becomes independent from the layer thickness for a high k value (k≧0.5). A constant reflectivity of 4.2%, 8.8%, and 15.6% has been found for a layer thickness larger than 100 nm for k is 0.5, 1.0, and 1.5, respectively. An effective reflectivity of 20% can be obtained for a reflective multilayer system (≧2 layers) for k=1.5 and an optimized thickness of the thermochromic recording layer.

From FIGS. 5a-c a maximum reflectivity is found for a layer thickness around 70 nm, 50 nm and 40 nm for k≧0.5 and n=1.0, 1.6 and 2.2, at elevated temperature/high intensity, respectively. Roughly for a layer thickness ≧100 nm and k≧0.5 the reflectivity is constant, independent of the layer thickness and slightly lower compared to the maximum value. The depth independent reflectivity is comparable or even higher with the prior art case (k≈0) for k≧1 n<1.6 or n>1.6. Note, for k>0.5 and n=1.6 the reflectivity is always higher compared to the prior art reflectivity for k≈0 and n=1.6.

An initiating absorption is needed to initiate the thermo- or photochromic effect. However, the maximal initiating absorption is limited by the number of layers in a multilayer system and the used filling ratio on the layer. The influence of an initial absorption of ˜8% in a layer with a thickness of ≧100 nm, e.g. 200 nm with k=0.013 and n=1.6, on the reflectivity and the signal contrast has been calculated. The reflectivity of the out-of-focus layer is ˜0.006% and 29%, 18%, and 16% for the in-focus layer for n=1.0, 1.6 and 2.2, at elevated temperature/high intensity, respectively.

Writing is based on heating the material above a threshold temperature where it loses the thermochromic properties and reverts permanently back to its non-reflective state with n matched to that of the surrounding substrate/spacer material and with k as low as possible. If the transition beyond the mentioned threshold is accomplished by or accompanied by degradation of the thermochromic material, care has to be taken that the material is chosen such that the average refractive index of the generated fragments closely matches that of the surrounding matrix. The maximal allowable value of k after writing is also limited by the number of layers in a multilayer system and the used filling ratio on the layer. An absorption after writing of ˜8% is obtained for a layer with a thickness of 200 nm, kₘₐₓ=0.013, and n=1.6. The reflectivity is 0% for k=0, but even for 0<k≧=kₘₐₓ the reflectivity is very small. The reflectivity of a written mark with k=kₘₐₓ=0.013 and n=1.6 is ˜0.006%. The modulation between a written (reflection≈0.006%) and an unwritten mark (Reflection 29%, 18%, and 16% for n=1.0, 1.6 and 2.2, at elevated temperature/high intensity, respectively) will be >99% despite the initial absorption of ˜8% and is independent of the layer thickness.

The reflectivity of the thermochromic recording layer can be further increased without sacrificing the in-focus absorption and the out-of-focus transmission by using some additional dielectric layers. An exemplary stack of one recording layer is shown in FIG. 6. The stack contains a recording layer P of a thermochromic material sandwiched between two dielectric layers I2, I3 having an index of refraction (n′=1.5) lower than that of the thermochromic material in the in-focus state, and further sandwiched between two dielectric layers I1, I4 having an index of refraction (n″=2.3) higher than that of the dielectric layers I2, I3 adjacent to the thermochromic material. The stack is deposited onto a polycarbonate substrate S and is covered with a protective layer C (cover or spacer for multilayers). Instead of using thermochromic material in the recording layer P, photochromic material can be used as well.

In FIG. 7 the optical performance of such a stack is given as a function of the thermochromic recording layer thickness. The transmission in the plot is corrected for the light lost at the air-cover layer interface. As can be seen from FIG. 7, in-focus reflection of about 40% and out-of-focus transmission of more than 99% is achieved with such a stack. Obviously, the out-of-focus transmission depends on the thermochromic material's k-value at ambient temperature. For larger k, the transmission decreases linear as shown in FIG. 8. The transmission of the out-of-focus layer is >96% for an absorption of ˜2% of a homogeneous thermochromic recording layer with a thickness of 28 nm.

The calculated reflectivity for an optimized stack as function of k is shown in FIG. 9 for three different refractive indices (1.8, 2.0 and 2.2) of the thermochromic material at elevated temperatures. The refractive index of the thermochromic material at ambient temperatures is 1.6. The transmission of the out-of-focus layers is >99% and the reflectivity is 35-38% for a refractive index of 1.8-2.2 and a k value of 1.5. The reflectivity is >20% for a refractive index of 2.2 independent of the k value. The reflectivity is >12% for a refractive index larger than 1.8 and a k value between 0.5 and 1.5.

Thus, using an optimized stack with a thermochromic material it is possible to increase the effective reflectivity of a Slayer system and a 20-layer system with a factor 2.5-7 and 2-5 compared to the effective reflectivity of a 2-layer BD RW system, respectively.

In an implementation of a ROM system the thermochromic recording layer is patterned (using conventional and established techniques, such as wet embossing, injection molding, (photo)lithographical techniques, micro-contact printing, vapor deposition) with the pit shape and depth optimized to give in reflection an optimal read-out and tracking signal just as in standard ROM systems. Apart from the small reflectivity, any feedback to the drive about the presence of the thermochromic effect is not required and can thus be largely compatible with standard, now available drives except for the need to compensate for the aberrations introduced by the varying focal depths.

It should be mentioned that in the following implementations tracks similar to current disk systems are shown. However, this is not meant to be limiting, other implementations e.g. in card systems with possibly non-scanning data access and/or 2D information coding are just as well possible, such as a non-scanning card with broad beam illumination and detection using CCD sensors. Further, it should be noted that the drawings are not on scale.

FIGS. 10a, b show side views of an implementation of a thermochromic ROM reflective system with combined amplitude and phase grating (FIG. 10a) and pure phase grating (FIG. 10b). The carrier comprises a substrate cover layer S, thermochromic layers 10 with embossed ROM structure and spacer layers R (possibly containing an adhesion layer). The indices of refraction of layers S, 10, R are identical at ambient temperature. The hatched area 20 indicates the optical beam shape, i.e. the area where the temperature increases significantly above ambient. The temperature increases significantly above ambient only in the beam waist.

Different options of implementations are possible for the reflective ROM system. In particular, apart from the implementations shown in FIG. 10, an implementation with a homogenous thickness of the single thermochromic layer is also possible. In FIG. 10c a second implementation for a pure phase grating is shown. In this case the layer thickness for the land and the pits is identical which is not the case in FIG. 10b. A practical implementation of FIG. 10c is shown in FIG. 11 using a homogeneous stack containing the thermochromic material. This homogeneous stack can be deposited relative easily and cheaply using conventional methods (sputtering, evaporation). Push pull/3-spots/DTD-tracking can be obtained just as in standard ROM systems for the implementations shown in FIGS. 10b and 10c. 3-spots/DTD-tracking can be used for the implementation shown in FIG. 10a, because push pull tracking is not possible.

Based on the optical profile a pit width around 265 nm could be used using a wavelength of 405 nm and a low NA of 0.6 (12.5 GB user density for a 12 cm disk). However, 25 GB user density for a 12 cm disk could be obtained using the thermochromic super-resolution effect, resulting in a 20-layer 500 GB 12 cm disk with DVD optics.

For a ROM implementation using a pure amplitude grating having a layer thickness ≧100 nm, i.e. a pit depth d≧100 nm, an initial absorption of ˜8% in the pits, and a pit filling ratio of 25% the average reflection, transmission and absorption of the out-of-focus layer is <0.0025%, ˜98%, and ˜2%, respectively. The pit reflectivity of the in-focus layer is 15-30% for 1≦n≦2.2 and k≈1.5 above threshold. The optimum reflectivity of ˜30% is found for n=1 and k=1.5 (see FIG. 5). The reflectivity of the lands in the in-focus layers is 0% resulting in a signal contrast of ˜100%. It is to be noted that this contrast is independent of the pit depth, and the reflection and the transmission of the in-focus and the out-of-focus layers are independent of the pit depth for d≧2100 nm.

This ROM disk can not be made by filling pre-embossed pits by spin coating, because the land will not remain free from the spin coated material resulting in a low contrast reflective disk. Instead a method based on wet-embossing to obtain a high contrast multilayer disk is preferably used.

The relationship between the signal contrast and the pit depth is shown in FIG. 12 for both a pure phase grating disk and the proposed pure amplitude grating disk. CA represents the central aperture data signal and DPD represents the type-1 differential phase detection signal for tracking. It can be seen that for a pure phase grating disk the signal contrast declines when the pit depth deviates from the optimum, while for the pure amplitude grating it always stays at about 100%. It should be noted that in the case of a pure amplitude grating the radial push-pull signal in principle disappears.

A DTD2 (differential time detection type-2) tracking method can benefit from the pure amplitude grating as well. During the derivation of the DTD2 signal, two pairs of diagonal quadrant signals (i.e., A+C and B+D, wherein, for instance, A is the upper left quadrant, B is the upper right quadrant, D is the lower left quadrant and C is the lower right quadrant) first need to be obtained and then their phase difference is compared. If these two signals have been maximally modulated, it leads to a more accurate phase comparison and in turn a better tracking error signal. Analogically, the relationship between the modulation of the signals A+C and B+D and the pit depth is plotted in FIG. 13. The filling ratio 25% is used in all calculations.

An implementation of the reflective embodiment on a WORM system shall now be explained. In principle, a high-to-low writing effect can be achieved simply by heating the material above a threshold temperature where it loses the thermochromic properties and reverts permanently back to its non-reflective state with the refractive index n matched to that of the surrounding substrate/spacer material. If the transition beyond the mentioned threshold is accomplished by or accompanied by degradation of the thermochromic material, care has to be taken that the material is chosen such that the average refractive index of the generated fragments closely matches that of the surrounding matrix.

A very positive feature of this writing concept, as used in the below described first implementation, is the resulting high value of the modulation (in principle 100%). This is important to achieve high data rates for high density systems where the highest data spatial frequencies lie close to the modulation transfer function cut-off and are thus strongly attenuated by the optical system. A high modulation therefore is directly beneficial for the achievable data rate.

In a first WORM implementation one single thermochromic material is used and deposited in the tracks. The thermochromic material can be used as such, or can be incorporated in a host matrix by dissolution, dispersion, adsorption on a binder, complexation etc. The layer thickness is chosen to provide adequate information and tracking signals. The concept is illustrated in FIGS. 14 and 15. It is to be noted that for illustration the tracks are shown as straight lines. Of course, e.g. timing information can be put into track wobble such as used in standard recording.

FIGS. 14a, b shows the a side view (FIG. 14a) and a top view (FIG. 14b) of the first implementation with unwritten tracks; FIGS. 15a, b shows the a side view (FIG. 15a) and a top view (FIG. 15b) of the first implementation with written tracks. Thermochromic material 50 is deposited in tracks and locally degraded as indicated by 60. The spacer layers R are index-matched and inactive. After writing, only the non-degraded parts of the track still show the thermochromic effect such that a modulation of the reflected light is achieved.

For the WORM implementation using a pure amplitude grating with a layer thickness ≧100 nm as shown in FIG. 14, an initial absorption of ˜8% in the grooves, a groove depth d≦100 nm, and a groove filling ratio of 50% the average reflection, transmission and absorption of the out-of-focus layer is <0.005%, ˜96%, and 4%, respectively, with written and unwritten marks. The reflectivity of a written mark in focus is <0.01% and of a unwritten mark is 15-30% for 1≦n≦2.2 and k≈1.5 above threshold. The optimum reflectivity of ˜30% is found for n=1 and k=1.5 (compare FIG. 5). The signal contrast resulting from the written and the unwritten marks is ˜100% for d≧100 nm. It should be noted that this modulation is independent of the pit depth, and the reflection and the transmission of the in-focus and the out-of-focus layers are independent of the pit depth for d≧100 nm.

The relationships between the signal contrast and the pit depth for both a pure phase grating disk and the proposed amplitude grating disk are similar to what has been shown in FIGS. 12 and 13. For unwritten area, the tracking can be achieved by, for instance, the twin-spot method. The twin-spot method is based on the variation of central aperture signals detected during radial scanning. Since the signals are maximally modulated with a pure amplitude grating in the radial direction, it can benefit from the invention as well.

A second WORM Implementation is illustrated in FIGS. 16 and 17. Therein another concept is applied using two materials with different degradation temperatures that both exhibit a thermochromic effect. FIGS. 16a, b shows the a side view (FIG. 16a) and a top view (FIG. 16b) of the first implementation with unwritten tracks; FIGS. 17a, b shows the a side view (FIG. 17a) and a top view (FIG. 17b) of the first implementation with written tracks.

The track predominantly consists of a thermochromic material 70 with a degradation temperature in the order of the typical process temperature encountered during the writing process. The track-groove is surrounded by material 80, also exhibiting thermochromic properties, but with a degradation temperature significantly higher than the temperatures encountered during the writing process. Due to this higher degradation temperature and the lower light intensity at the edge of the pre-grooved track (i.e. a lower temperature) compared to the intensity in the center of the laser spot, only material 70 will be degraded during writing as indicated in FIG. 17a by 90.

Again, the thermochromic materials can be used as such, or can be incorporated in a host matrix by dissolution, dispersion, adsorption on a binder, complexation etc. The track-groove can be fabricated using for instance conventional techniques such as embossing or micro-contact printing.

An advantage of this implementation is that continuous servo signals are generated in both the unwritten and written state. The achieved contrast in this implementation depends on the detailed layout and material properties of the recording stack. The “land”-layer made from material 80 has a maximum thickness of d₁+d₂ with the extra extension beneath the storage layer of thickness d₁. FIGS. 16 and 17 show an implementation, but there are other variations possible, e.g. a layer with homogeneous thickness having d₁=0 and d₂=0

Another concept is to use the optimized stack shown in FIG. 6 with pre-embossed tracks (FIGS. 18 and 19). Transparent marks are written by degradation of the thermochromic material 50 locally using an intense laser pulse. No light will be reflected from the degradated marks 60. A read-out and tracking (push pull/3-spots) signal can be obtained for 0<d<λ/2n and d≠λ/2, with d the track depth. DTD can only be used for pits (ROM) and not for grooves (WORM). A maximal read-out signal with 3-spots tracking (push pull is zero) and with a maximal contrast (in principle 100%) can be obtained from the remaining active parts 50 of the tracks using a track depth of λ/2n.

Further investigations have been made to find out what would happen if the refractive index change Δn would be negligible or the refractive index n would decrease instead of increase. The calculated reflectivity for the refractive index range 1.0-2.2 and for k=0, 0.1, 0.5 and 1.5 for a record carrier having a single thermochromic or photochromic layer (as shown in FIG. 1a) is shown in FIG. 20.

The initial refractive index of the substrate has been taken as 1.6, which is a representative refractive index value for standard polycarbonate-based substrates, for instance. The two lines with the same marking indicate the minimal and maximal reflectivity for a particular k value. This reflectivity range for a particular k value is determined by the layer thickness as shown in FIG. 5. The reflectivity is strongly dependent on the layer thickness for low k values (≦0.1). For k≈0 the reflectivity is an almost undamped oscillating function as function of the layer thickness. Therefore, different values of the layer thickness result in a similar reflectivity and thus only one value for the reflectivity has been used in FIG. 20 for k≈0. For k>0 a maximal reflectivity value is found for a thickness of ˜75 nm, ˜50 nm, and ˜40 nm for a change of n from its initial value of 1.6 to 1, 1.6 and 2.2, respectively. For k>0 a constant and minimal reflectivity value for this application is found for a thickness of >50 nm, >30 nm, and >25 nm for a change of n from its initial value of 1.6 to 1, 1.6 and 2.2, respectively.

Thus, for k≈0 the reflectivity increases from almost zero up to 10% and 20% for a value of n of 2.2 and 1.0, respectively. For 0<k<0.5 the reflectivity decreases for n≈1 and n≈2.2 compared to the case with k≈0. The reflectivity increases a few percents for 1.2<n<2.2. Further, for 0.5<k<1.5 the reflectivity increases from 10% and 20% up to 20% and 30% for n≈2.2 and n≠1.0, respectively. The reflectivity increases from almost zero up to 22% for n≠1.6, which is very surprisingly. Simultaneously, with the increased reflectivity also a resolution enhancement is obtained by optimizing n and k.

What happens with the reflectivity when n is changed from 1.6 to 2.2 while simultaneously k is changed from 0 to 1.5 is shown with the dotted graph in FIG. 21. Without illumination n is 1.6 and the blue graphs starts with a reflectivity of 0%. While increasing the illumination both n and k increase. The dotted graph crosses the other graphs for k=0.1, 0.5, 1.0 and 1.5 when n=1.9, 2.05, 2.15 and 2.2, respectively. It is to be noted, that at the crossings of the graphs the k values are identical. This case (dotted graph) is compared in FIG. 22a with the known situation in which the reflectivity is optimized by only increasing n without optimizing k. For both cases the reflectivity is almost similar for a change of n from 1.6 up to 1.9. However, for larger values of n the reflectivity increases faster while simultaneously increasing k (dotted line of FIG. 22a) compared to the case in which k is not changed.

The intensity profile of a diffraction-limited spot is described by a sinc-function and can be approximated with a Gaussian-function. The increased resolution, due to the prior art thermochromic effect, is obtained by the non-linear increase of the reflectivity towards the center of the spot. The corresponding reflectivity as function of the position of the spot is schematically shown by the continuous graph in FIG. 22b. The faster increase of the thermochromic reflectivity towards the center of the spot, due to the simultaneous increase of n and k, results in a further resolution enhancement (dotted graph of FIG. 22b). The reflectivity as function of the position has also been approximated in FIG. 22b by a Gaussian profile and a resolution enhancement with roughly a factor 1.3 has been found (FIG. 22b). The 2D-resolution enhancement would be ˜1.7.

From FIG. 20 it can be concluded that for a multi-layer record carrier (as shown in FIG. 1b) based on the single-layer configuration the reflectivity increase for k≈1.5 and n≈1.6 is not almost zero as expected, but up to 22%, and thus even larger compared to the case above with k≈1.5 and 1.6<n≦2.2. The reflectivity increase is larger for a decrease of n compared to an increase of n or when n is not changed. The reflectivity can become up to 20% for k≈0 and n≈1.0, and the reflectivity can become up to 30% for k≈1.5 and n≈1.0. Further, an additional resolution enhancement factor of ˜1.7 (2D) based on the proposed method can be obtained which can also be used to increase the system margins without increasing the spatial resolution. The case in which n is changed from 1.6 to 2.2 and k from 0 to 1.5 has been used to explain the resolution enhancement method, but the method is also applicable for the case in which n is changed from 1.6 to 1.0 and k from 0 to 1.5.

As described above with reference to FIGS. 6 to 8, the reflectivity of the recording layer can be further increased without sacrificing the in-focus absorption and the out-of-focus transmission by using some additional dielectric layers. The identical stack design of FIG. 6 has been used to calculate the reflectivity of the stack for 1≦n≦2.2 and k=1.5 starting with n=1.6 and k=0 (see FIG. 23). The transmission of the out-of-focus layers is >96% for the initial value of k≦0.02.

It has been found that for k=1.5 the reflectivity is ˜45% for n≈2.2 and increases gradually up to 55% while decreasing n down to 1.0. This leads to the conclusions that the reflectivity increase of an optimized thermochromic stack is larger for a decrease of n compared to an increase of n or when n is not changed. Further, the reflectivity can become up to 55% for k≈1.5 and n≈1.0, and the reflectivity can become up to 46% for k≈1.5 and n≈1.6.

The n and k values are optical constants of the materials, which are wavelength dependent. Above the threshold temperature or threshold intensity the absorption band shifts towards another wavelength. Thus, also the spectral dependency of n and k will shift towards another wavelength. The k value is maximal at the wavelength of maximum absorption, and after the spectral shift this maximum k value will not change. However, different materials can have different maximum k values. Thus, the k value at a particular wavelength will change above the threshold temperature (TC) or threshold intensity (PC), due to the spectral shift. An initiating absorption is needed to initiate the TC/PC-effect and this initial absorption is limited by the number of layers and the used filling ratio (˜25% for ROM and ˜50% for WORM). The relation between absorption A and k is: A=1−exp(−4πdk/λ) with d the layer thickness and λ the used laser wavelength. It should be noted, that for a particular absorption at a particular wavelength dk=constant. For example, an initial absorption of ˜8% is obtained for a layer with a thickness of 200 nm, k=0.013, n=1.6, and λ=405 nm. For a layer thickness ≧30 nm the reflectivity is always ≧9% for 1≦n≦1.6 and k≧1.0 above threshold. Thus an initial absorption of ˜8% can be found using a material with an initial k≦0.085 and d≧30 nm.

The selection procedure of a particular material is as follow:

Select a TC/PC-material with a low initial k value at the interesting laser wavelength (200-800 am), e.g. k≦0.085 to obtain an initial absorption of ˜8% at 405 nm, to obtain a high transmission of the out-of-focus layers.

The maximum k value of the selected material should be ≧1.

The k value of the material should increase above 0.5 above the threshold temperature/intensity and preferable above 1 to obtain a reflectivity enhancement in the in-focus layer compared known materials.

The range of the refractive index at the threshold temperature/intensity is 1<n<4, and the preferable range 1<n<1.6 (with n=1.6 the refractive index of the surrounding layers, which can vary between 1.4<n<1.7). The range 1<n<1.6 is preferable because a further increase of the reflectivity is obtained by increasing k and decreasing n simultaneously.

Both a blue- and a red shift can be used, but the blue shift is preferred. A decrease of n is obtained applying a blue shift (1<n<1.6) and an increase of n is obtained applying a red shift (1.6<n<4).

The predicted high reflectivity based on a high k value has been verified experimentally. The calculate air incident reflectivity of a dye S5013 layer (see FIG. 4) with a thickness d≧0 nm on a glass substrate (n≈1.52) around 440 nm is 30-33%. The calculated optimum air incident reflectivity of 33% is found for a thickness of ˜50 nm. It should be noted, that the reflectivity is ˜23% for substrate incident, like in a multilayer disk. The experimental measured n and k values are shown in Fig. with n≈1.2 and k≈0.1, and n≈1.5 and k≈1.5 at 320 nm and 440 nm, respectively. The measured reflectivity is shown in FIG. 24 with an air incident reflectivity of ˜3% and ˜36% around 320 nm and 440 nm, respectively, for a thickness of 80+/−25 nm (FIG. 24). The measured reflectivity at 440 nm is higher than expected and could be caused by a slightly higher k value of 1.6 instead of 1.5. For substrate incident the reflectivity of this dye layer would be ˜0% and ˜25% around 320 nm and 440 nm, respectively. It should be noted, that both absorption and reflection spectra have a maximum at 440 nm, and the transmission spectrum are minimum at this wavelength.

The PC material is bistable and the TC material is not. For TC-materials n and k return back to their initial values after decreasing the temperature below the threshold temperature. Under light illumination the structure of the PC-material is changed resulting in a change of n and k. To return back to the initial optical constants an other illumination wavelength is required. This requires a more complicated optical system to switch on and read out the PC-material using one laser spot and to switch of the PC-material with another laser spot with another wavelength. This possible implementation using a PC-material is illustrated in FIG. 25 which shows an optical implementation using PC-material. One laser beam L1 with a wavelength within the absorption band is used to change the optical constants (n,k) of the PC-material. Simultaneously the data is read out. A second laser beam L2 with a different wavelength, within the shifted absorption band, is used to bring the optical constants (n,k) of the PC-material back to their initial values. S1 indicates the switch on and read out spot, S2 indicates the switch off spot. The arrow indicates the rotating disk direction.

A higher physical density can be obtained using optical equalization by blocking the central aperture of the focusing lens of the recording apparatus or by applying a donut shaped beam on the lens. However, this effect is not applicable for conventional record carriers because the jitter becomes too large due to the simultaneously increased intersymbol interference (ISI) from neighboring bits.

The physical density can be increased using optical equalization by blocking the central aperture of the lens or by applying a donut shaped beam on the lens in combination with non-linear materials as proposed according to the present invention. The non-linear effect is used to keep the jitter at an expectable level while increasing the physical density. Thermo- or photochromic materials are used to obtain the non-linear effect as described above.

While the central peak becomes smaller, energy is transferred to the side lobes of the Airy-pattern, increasing their size (FIG. 26). A decrease of the spot size with a factor up to 1.9 is feasible. A decrease of the spot size increases the modulation transfer function (MTF) of the higher frequencies at the expense of the MTF of the lower frequencies. A higher physical density is obtained using this optical equalization while the jitter remains at an acceptable level. Normally, this effect cannot be used effectively to increase the physical density, because the side lobes are interpreted as intersymbol interference (ISI) from neighboring bits and tend to close the eye-opening. In the case of non-linear absorption or reflection, the detected signal will show these side lobes to a much lesser extent (FIGS. 27 and 28). The non-linear effect as shown in FIG. 22 has been used to visualize the decrease of the side lobes. In FIG. 27a the reflectivity as function of n is shown for the optimized case (dotted graph) and for the known case (continuous graph). In FIG. 27b the corresponding reflectivity profile along the spot of an annular lens for the known case (continuous graph) and of the optimized case (dotted graph) is shown. The reflectivity of the side lobes of the spot is not changed while the reflectivity of the central peak is amplified due to the non-linear effect. Normalizing both reflectivity profiles (FIG. 28) a decrease of the reflectivity of the side lobes with a factor 2 compared to the reflectivity of the central peak is observed. The illustrated decrease of the reflectivity of the side lobe is an additional decrease on the existing thermo- or photochromic induced decrease. The total decrease will be even larger.

The method can be implemented in different ways. To achieve a significant gain by using this method, most of the central part of the lens aperture is blocked, e.g. using a light blocker in front of the lens as shown in FIG. 29, resulting in a significant loss of power for a normal overfilled lens: almost 80% power loss to achieve a spot area decrease with a factor of ˜1.9.

Another possibility is to use a donut shaped beam. To keep energy loss at a tolerable level, beam shaping optics could be used that produce a radial intensity profile which is peaked not at r=0 but at rₚₑₐₖ=(R_{block}+Rₗₑₙₛ)/2, the so-called donut beam as shown in FIG. 30.

It should be remarked that the physical density increase is also applicable for fluorescent storage, which is a special type of absorbing storage and for multilayered storage.

However, a further increase of the data density often results in an increase of the aberrations of the optical storage system. The blue-DVD system and the multilayer system will be discussed as practical examples. FIG. 31 shows the intensity of the spot of a DVD+RW lens in a disk with a substrate thickness of 0.6 mm (FIGS. 31a, b) or 0.65 mm (FIG. 31c) is shown. Changing the wavelength of the DVD system from red (660 nm; FIG. 31a) to blue (405 nm; FIG. 31b), while keeping the information layer at a depth of 0.6 mm, results in a decrease of the tilt margins. The energy of the central peak of the focused spot is transferred to the side lobes when the disk is tilted. These increased side lobes increase the intersymbol interference (ISI) from neighboring bits and thus the jitter. The increase of the side lobes, due to tilt, is also inverse proportional with the wavelength of the light.

In multilayer disk one factor limiting the useable NA is the presence of aberrations, which strongly increase with the NA. In the case of single or even dual layer systems, this is tolerable since the objective lens is compensated for the known position of the focus in the medium or in between the two possible layers. For multilayer applications the aberrations are a function of the addressed layer's depth and have to be compensated by adaptive optics. However the range of compensation is also limited: the liquid crystal (LC) compensator, which has been designed to compensate the spherical aberrations in the dual layer BD, can compensate for a spherical aberration (SA) peak-peak error of ˜1λ. Therefore, using the LC compensator, a depth range of ˜30 μm and ˜400 μm can be obtained for a DVD (NA=0.60) and BD (NA=0.85) based multilayer system. Also for SA the energy of the central peak of the focused spot is transferred to the side lobes when the lens is focused on another layer at a different depth in the disk (FIG. 31c).

Less aberrations for an absorbing or reflective optical storage system can be obtained by using the non-linear effect of thermo- or photochromic materials described above. In the case of blue-DVD the non-linear effect can be used to increase the tilt margins. In the case of multilayer storage it can be used to increase the depth range.

The transfer of the energy of the focused spot of a red DVD lens from the central peak to the side lobes is shown in FIGS. 31b and 31c, for tilt and SA, respectively. In the case of non-linear absorption or reflection, the detected signal will show these side lobes to a much lesser extent as has been explained above with reference to FIGS. 26 to 30. There, it has been described that a physical density enhancement can be obtained by using an annular lens. However, the decrease of the width of the central peak occurs simultaneously with an increase of the intensity of the side lobes and thus an increase of the jitter. These detected side lobes can be suppressed by applying the non-linear effect according to the present invention, which is illustrated in FIG. 28. The same non-linear method can be applied to decrease the detected side lobes induced by tilt (FIG. 31b) or by SA (FIG. 31c).

The small tilt margins of an absorbing or reflective blue-DVD system can be enhanced by using the non-linear effect according to the invention. Further, the depth range of an absorbing or reflective multilayer storage system can be increased by using the non-linear effect according to the invention. Therefore, using the LC compensator, a depth range of >30 μm and >400 μm can be obtained for a DVD (NA=0.60) and BD (NA=0.85) based multilayer system. For other SA compensation optics the depth range can be smaller or larger.

Further, the NA of an absorbing or reflective multilayer storage system can be increased while keeping the aberrations (e.g. tilt SA, coma and astigmatism) at an acceptable level by using the non-linear effect according to the invention. The intensity of the detected side lobes of a spot with coma aberrations also increases at the expense of the intensity of the detected central peak. Furthermore, the broadening of the reflected intensity profile, due to astigmatism, will be less on a non-linear reflecting surface compared to a linear reflecting surface. Thus, also coma and astigmatism aberrations can also be decreased using the non-linear effects of thermo- or photochromic materials.

It should be remarked that the aberrations reduction is also applicable for fluorescent storage and all optical storage systems based on a linear response by applying a non-linear response.

A WORM concept based on thermochromic materials has been described above with reference to FIGS. 14-19. In principle, a high-to-low writing effect can be achieved simply by heating the material above a threshold temperature where it loses the thermochromic properties and reverts permanently back to its non-reflective state with the refractive index n matched to that of the surrounding substrate/spacer material, e.g. 1.6 for polycarbonate (PC). In the case of photochromic materials a threshold intensity is used. If the transition beyond the mentioned threshold is accomplished by or accompanied by degradation of the thermochromic/photochromic material, care has to be taken that the material is chosen such that the average refractive index of the generated fragments closely matches that of the surrounding matrix. A mismatch of the refractive index results in a decrease of the signal contrast and the transmission of the out-of-focus layers.

It is therefore proposed to optimize the signal-contrast of the in-focus layer and the transmission of the out-of-focus layers if a refractive index mismatch would occur in the written marks after recording. For every refractive index mismatch an optimized layer thickness of the thermochromic/photochromic material can be found with maximum contrast (˜100%) and optimum transmission for a given initial absorption, without scarifying the signal strength (often also called signal modulation).

The reflection (R), transmission (T), absorption (A), and signal contrast (C) of a single layer thermo-/photochromic (TC/PC) recording stack in- and out-of-focus before (unwritten mark) and after writing (written mark) for different cases are shown in FIG. 32. The refractive index (n_{PC}) of polycarbonate (PC) is taken 1.6 at 405 nm. After writing with (FIG. 32a) the refractive index of the written TC/PC mark (n=1.6) matched with the refractive index of PC (n_{PC}) for a groove depth of 200 nm, (FIG. 32b) a refractive index mismatch of Δn=0.3 (n_{w}=1.3) with an optimal depth of 156 nm, (FIG. 32c) a refractive index mismatch of Δn=0.6 (n_{w}=1.0) with an optimal depth of 202 nm, (FIG. 32d) a refractive index mismatch of Δn=0.6 (n_{w}=2.2) with an optimal depth of 184 nm, (FIG. 32e) a refractive index mismatch of Δn=0.6 (n_{w}=2.2) with an optimal depth of 92 nm. In all FIG. 32 the following graphs are shown as function of the groove depth: the reflectivity of an unwritten mark in-focus for n=1.0 (R_{unw1.0}) and 1.6 (R_{unw1.6}) and k=1.5 above threshold, the reflectivity of a written mark in-focus with 8% absorption after writing for both n=1.0 and 1.6 (R_{w}), the signal-contrast between the written and unwritten marks in-focus for n=1.0 (C_{1.0}) and 1.6 (C_{1.0}) and k=1.5 above threshold, and the average transmission (T_{oof}) of the out-of-focus layers after writing using a groove/land ratio of 50% and the given (optimal) groove depth.

The reflection, transmission, absorption and signal contrast of a single layer TC/PC-recording stack in- and out-of-focus before and after writing for different cases are also given in the following table. The meaning of the terms used therein and in FIG. 32 is as follows:

a) n_{w} is the real part (n) of the complex refractive index of a written mark (w). The effect of a refractive index mismatch after writing of Δn_{w}±0.6 relative to n_{w}=1.6 has been taken into account (n_{w}=1.0 and n_{w}=2.2).

b) n_{unw} is the real part (n) of the complex refractive index of an unwritten mark above threshold (unw). n of an unwritten mark is 1.6 below threshold.

c) dₒₚₜ is the optimum thickness of the TC/PC-layer.

d) T_{oof} is the average transmission (T) of the out-of-focus (oof) layer. The ratio of the pregrooved WORM medium is 50%.

e) A_{oof} is the average absorption (A) of the out-of-focus (oof) layer. The ratio of the pregrooved WORM medium is 50%.

f) k is the imaginary part of the complex refractive index of a written mark in- and out-of-focus and a unwritten mark out-of-focus.

g) C is the signal-contrast of the written- and unwritten marks in-focus.

h) R is the reflectivity of the written and unwritten marks in- and out-of-focus.

| | | | | | | | R | | |
|---|---|---|---|---|---|---|---|---|---|
| | | | | | | | [%] | | |
| n_{w} | n_{unw} | dₒₚₜ | T_{oof} | A_{oof} | k | C | | | w_{if}/ |
| [−] | [−] | [nm] | [%] | [%] | [−] | [%] | unw_{if} | unw_{oof} | w_{oof} |
| 1.6 | 1.6 | 200 | ˜96 | ˜4 | 0.013 | 100 | 18 | 0.006 | 0.006 |
| | (1.0) | | | | | (100) | (29) | | |
| 1.3 | 1.6 | 156 | ″ | ″ | 0.017 | 100 | 18 | 0.005 | 0.007 |
| | (1.0) | | | | | (100) | (29) | | |
| 1.0 | 1.6 | 202 | ″ | ″ | 0.013 | 99.8 | 18 | 0.006 | 0.037 |
| | (1.0) | | | | | (99.9) | (29) | | |
| 2.2 | 1.6 | 184 | ″ | ″ | 0.014 | 99.9 | 18 | 0.007 | 0.016 |
| | (1.0) | | | | | (99.9) | (29) | | |
| | 1.6 | 92 | ″ | ″ | 0.028 | 99.9 | 18 | 0.016 | 0.015 |
| | (1.0) | | | | | (99.9) | (30) | | |

The case for k=1.5 at elevated temperatures and for a matched refractive index around 1.6 after recording at 405 nm is shown in FIG. 32a and the first row of the above table. The in-focus reflectivity of the unwritten marks is ˜18% and depth independent for a layer thickness of ≧20 nm and n=1.6 above threshold. The in-focus reflectivity of the unwritten marks is ˜29% and depth independent for a layer thickness of ≧50 nm and n=1.0 above threshold. The signal contrast is for every layer thickness 100% for both n=1.6 and n=1.0 above threshold. The out-of-focus transmission depends on the thickness, the groove/land ratio (often also called filling ratio), and k and is ˜96% for a 200 nm thick pregrooved WORM layer with an initial absorption of 8% (k=0.013) and a groove/land ratio of 50%. The reflectivity of the refractive index matched written marks with a maximal absorption of 8% (k≈0.013) is ˜0.006% for both the in-focus and out-of-focus layers. The reflectivity of the unwritten marks in the out-of-focus layers at ambient temperature is also ˜0.006%.

For a refractive index mismatch of the written mark with n=1.3 instead of 1.6 after recording, e.g. by degradation, a decrease of the contrast and the out-of-focus transmission is observed (FIG. 32b and second row of the above table). The contrast decreases down to 75%, due to an increase of the reflectivity of the written mark while the reflectivity of the unwritten mark remains the same. However, for a layer thickness of ˜156 nm a maximum contrast of ˜100% is found with an average initial absorption of 4% (k=0.017) and an average transmission of ˜96% for the out-of-focus layers (FIG. 32b).

The contrast decreases down to 0% and 50% for a refractive index mismatch of the written mark of n=1.0 and n=2.2 instead of 1.6, respectively (FIG. 32c and third row of the above table, and FIGS. 32d-e and forth row of the above table, respectively). An optimal layer thickness of 202 nm with a contrast ≧99.8% is found for a refractive index mismatch of the written mark of n=1.0 instead of 1.6 (FIG. 32c). An optimal layer thickness of 184 nm and 92 nm with a contrast ≧99.9% is found for a refractive index mismatch of the written mark of n=2.2 instead of 1.6 (FIGS. 32d and 32e, respectively). The average values of the absorption, the transmission, and the reflectivity of the out-of-focus layers with the optimal groove depth is 4%, ˜96%, and ≦0.02% for all described cases, respectively (FIGS. 32b-e). The in-focus reflectivity of the refractive index mismatched written marks with the optimal depth is ≦0.04% for all described cases (FIGS. 32b-e)

Based on the above findings and measurements a method is proposed to optimize the signal-contrast of the in-focus layer and the transmission of the out-of-focus layers if a refractive index mismatch Δn would occur in the written marks after recording. For every refractive index mismatch Δn an optimized layer thickness dₒₚₜ can be found with maximal contrast (˜100%) and maximal transmission for a given initial absorption, without scarifying the signal-strength.

The steps of the proposed method are as follows:

Select a TC/PC material with a low initial k value (e.g. kᵢₙᵢₜᵢₐₗ<0.5) around a first wavelength (e.g. 405 nm) and a high k value (e.g. kₘₐₓ≧0.5) at a shorter or longer second wavelength before writing. During read-out at the first wavelength (405 nm) k should become higher than the initial value (kₘₐₓ≧0.5) and again drop down to the initial value (kᵢₙᵢₜᵢₐₗ<0.5) after read-out.

Before writing the refractive index of the TC/PC-material should be matched to that of the surrounding substrate/spacer material, e.g. ˜1.6 for polycarbonate (PC) around 405 nm.

Measure the refractive index mismatch Δn at the first wavelength (405 mm) after recording.

Calculate the smallest optimized layer thickness dₒₚₜ of the TC/PC-materials (examples can be found in FIG. 32 and the above table for a refractive mismatch of Δn=−0.3 and Δn=±0.6).

Calculate the maximal initial k value (kᵢₙᵢₜᵢₐₗ₋ₘₐₓ) at the first wavelength (405 nm) for the optimized layer thickness dₒₚₜ before writing to obtain a minimal transmission of the out-of-focus layers. The out-of-focus transmission depends on the thickness, the groove/land ratio and k, e.g. the out-of-focus transmission is ˜96% for a 200 nm thick pregrooved WORM layer with an initial absorption of 8% (kᵢₙᵢₜᵢₐₗ₋ₘₐₓ=0.013) and a groove/land ratio of 50%. It should be noted, that the material is not useful if before writing kᵢₙᵢₜᵢₐₗ>kᵢₙᵢₜᵢₐₗ₋ₘₐₓ and after writing k_{after-writing}>kᵢₙᵢₜᵢₐₗ₋ₘₐₓ. The signal-contrast (˜100%) and the transmission of the out-of-focus layers (˜96%) for a refractive index mismatch Δn in a written mark after recording has know been optimized at the first wavelength (405 nm).

The matrix formalism for multiple-beam interference at parallel interfaces is used to calculate the reflection, the absorption and the transmission of the addressed and the non-addressed layers as illustrated in FIG. 33 and as described in M. V. Klein, T. E. Fuita, Optics-second edition, John Wiley & Sons, (1986).

The reflection and transmission coefficient ρᵢⱼ and τᵢⱼ, respectively, at an interface between two different media at perpendicular light incidence is

$${ρ}_{ij} = \frac{{n}_{i} - {n}_{j}}{{n}_{i} + {n}_{j}} , \\ and$$

$${τ}_{ij} = \frac{2 {n}_{i}}{{n}_{i} + {n}_{j}} .$$

In crossing a given layer from the left side to the right side a phase factor exp(−iβⱼ) is introduced where

$${β}_{j} = \frac{2 Π}{{λ}_{0}} {n}_{j} {d}_{j} .$$

The stack matrix is given by
S=H_{I2}L₂ . . . . L_{N-1}H_{N-1,N}
with the interface transition matrix

$${H}_{ij} = \frac{1}{{τ}_{ij}} ( \begin{matrix}1 & {ρ}_{ij} \\ {ρ}_{ij} & 1\end{matrix} ) ,$$

and the layer propagation matrix

$${L}_{j} = ( \begin{matrix}exp ( - ⅈ {β}_{j} ) & 0 \\ 0 & exp ( ⅈ {β}_{j} )\end{matrix} ) .$$

The stack shown in FIG. 34 has been used to calculate the total transmission, reflection and absorption of the TC/PC layer for both the addressed and the non-addressed layers. The reflection at the air-polycarbonate interface has not been taken into account. For an unwritten mark n_{TC-unwritten}=1.6−(kᵢₙᵢₜᵢₐₗ)i at ambient temperature and n_{TC-unwritten}=1.6−(1.5)i at elevated temperatures with kᵢₙᵢₜᵢₐₗ≦kᵢₙᵢₜᵢₐₗ₋ₘₐₓ. For a written mark n_{TC-written}=n_{after writing}−(k_{after writing})i with k_{after writing}≦kᵢₙᵢₜᵢₐₗ₋ₘₐₓ. n_{PC}=1.6 and is matched with n_{TC-unwritten} at ambient temperature. If Δ=n_{after writing}−n_{before writing}≠0 the contrast between the written and the unwritten marks in the addressed layer decreases due to the refractive index mismatch. However, minimizing the reflectivity of a written mark by tuning its thickness can increase this contrast. This optimized thickness dₒₚₜ for the written mark can be calculated with the above described matrix formalism by calculating the contrast as function of the thickness of the TC-layer (examples can be found in FIG. 32 and the above table for a refractive mismatch of Δ=−0.3 and Δ=±0.6). The maximum value of the contrast for d>30 nm determines the value of dₒₚₜ. It should be noted that the reflectivity of an unwritten mark is independent of its thickness, and thus a thickness identical to the optimal thickness of a written mark will be used.

The minimal allowable transmission of the non addressed layers determines the value of kᵢₙᵢₜᵢₐₗ₋ₘₐₓ. The total absorption A in a non addressed layer with a transmission T and an almost negligible reflection R is
A=1−T−R≈1−T.

The relation between the absorption and the imaginary refractive index k is

$$A = 1 - exp ( \frac{- 4 Π dk}{λ} )$$

with the thickness of the layer d and the wavelength of the light λ. A value of 0.013 is found for k_{initial max} for a pregrooved WORM layer with a groove/land ratio R_{L/G} of 0.5, a minimal allowable transmission of the non addressed layers Tₘᵢₙᵢₘₐₗ of 0.96, an optimal thickness dₒₚₜ of 200 nm and a wavelength λ of 405 nm using

$${k}_{initial - max} = ( - \frac{λ}{4 Π {d}_{opt}} ) ln ( - \frac{0.5 - {T}_{minimal}}{{R}_{LIG}} ) .$$

The WORM implementation using a pure amplitude grating for a layer thickness larger than 100 nm as described above can be used by tuning the groove depth to obtain an optimal signal-contrast, signal-strength and out-of-focus transmission. Moreover, this idea can also be applied in multiple layer and single layer reflective optical disk systems, like CD, DVD and BD.

The low thermal stability of the TC/PC organic dyes could be a serious problem during read-out. TC-read-out is based on the reversible change of the optical constants (n and k) upon heating and cooling. PC-read-out is based on the reversible change of the optical constants (n and k) upon illumination with two laser beams with different wavelength. Heating the organic material above the decomposition/degradation temperature could be used as a writing effect.

However, a writing effect would occur if the temperature would exceed above the decomposition temperature during read-out. In the proposed TC/PC multilayer recording media preferably TC/PC materials and low thermal conductive materials (polycarbonate, SiO₂, Si₃N₄) are used. Thus, the temperature could increase above the decomposition temperature during read-out, because of the high absorption using high k values (0.5<k<1.5). A temperature <70° C. is preferable during read-out, because the decomposition temperature of organic dyes is >70° C. It appears from thermal calculations that with k=1.5 and a TC/PC-layer thickness of 50 nm a temperature of about 130° C. can be reached if 21.12 m/s (4× BD/6× DVD) speed and 0.3 mW read power are used. The temperature will decrease at higher disk speeds and lower read-out powers. However, lower laser powers are not a realistic option, because in order to reach the SNR requirements for bit detection the data rate will be dramatically limited due to the laser and especially the electronic noise.

A comparison between the calculated channel bit rate (CBR) of a conventional DVD+RW single layer system based on phase change materials and a DVD-WORM multilayer medium based on TC/PC-materials is listed in the following table. The CBR of the conventional DVD system with 14% reflectivity (R), a laser power (Pₗₐₛₑᵣ) of 0.7 mW on the disk and a PDIC detector is 146 Mbps. Using a 10 times lower laser power of 0.07 mW on the disk for a TC-multilayer system (read-out temperature will be <130° C.) results indeed in a dramatic decrease of the CBR to 16 Mbps due to the increase of the laser noise (RIN; from −125 dB to −115 dB).

Possible solutions to increase the CBR up to acceptable levels while keeping the laser power low are also listed in the following table, e.g. grey filter (indicated in the fifth column by ‘filter’) to decrease the laser noise, avalanche photodiode (APD) to decrease the electronic noise, and multi-track read-out to boost the CBR without optical power loss. Using an output laser power of 3.5 mW (two times more compared to the conventional DVD+RW system) and decreasing the laser power with a factor 20 using a grey filter gives a laser power of 0.07 mW on the disk. The use of the grey filter decreases the laser noise with 20 dB, resulting in a CBR enhancement with a factor 6 (from 16 to 93 Mbps), which is limited by the electronic noise. A further CBR increase with a factor 2 (from 93 to 204 Mbps) can be obtained by using the APD. A drawback of the use of the grey filter is the loss of 90-95% of the optical power.

This optical power loss problem is solved according to the present invention by using a multi-spot grating, e.g. a 10-spots grating, instead of a grey filter with an attenuation factor of 10. A CBR of ˜700 Mbps is found using a conventional read-out laser power of 1.75 mW, a 10-spot grating and a conventional PDIC detector. A CBR of ˜1.2 Gbps is found using a conventional read-out laser power of 1.75 mW, a 10-spot grating and a PIN-based APD detector. It should be noted that examples of TC organic dyes with a decomposition temperature >200° C. have been described in A. Nomura et. al, ‘Super-Resolution ROM disk with Metal Nanoparticles or Small Aperture’ Jpn. J. Appl. Phys. 41, 3B, 1876 (2002).

The calculated channel bit rate with 20 dB signal-to-noise ratio (SNR) taking into account the laser noise, the electronic noise and the detector noise is listed in the following table. The SNR will become 10-15 dB (9-16% jitter) at the same channel bit rate when also the quantization noise of the AD converter and the media noise are taken into account.

| | | | | | 10- | | | |
|---|---|---|---|---|---|---|---|---|
| | R | Pₗₐₛₑᵣ | RIN | Filter | spots | P_{disk} | Detector | CBR |
| | [%] | [mW] | [dB] | [dB] | grating | [mW] | [Mbps] | [Mbps] |
| DVD + RW | 14 | 1.75 | −125 | — | — | 0.7 | PDIC | 146 |
| Phase change | | | | | | | | |
| single layer | | | | | | | | |
| DVD- | 20 | 0.175 | −115 | — | — | 0.07 | PDIC | 16 |
| WORM | | 1.75 | −125 | 10 | | | | 74 |
| TC/PC | | 3.5 | −135 | 20 | | | | 93 |
| multilayer | | | | | | | APD | 204 |
| | | 1.75 | −125 | 10 | | | (PIN) | 124 |
| | | | | — | used | | | 1240 |
| | | | | | | | PDIC | 740 |

The mentioned detectors are:
PDIC: 0.5 pA/Hz^{1/2}, 8.8 nV/Hz^{1/2}, 0.7 pF, 0.5 A/W@650 nm;
APD(PIN): 0.5 pA/Hz^{1/2}, 2.2 nV/Hz^{1/2}, 9 pF, 0.5 A/W@650 nm, M=10, F_{exc}=2.5.

The Avalanche PIN (APD(PIN)) has an excess noise factor F_{exc}=2.5 using a multiplication M=10.

There are different possible implementations for a ROM/WORM system. In a first implementation an acceptable CBR is obtained for a DVD-ROM/WORM multilayer system using a grey filter and an APD detector, while keeping the read-out temperature in the disk at acceptable levels. In a second implementation, a CBR enhancement with roughly a factor 5 for a DVD-ROM/WORM multilayer system compared to a conventional DVD+RW single layer system is obtained using the multi-track approach (both for 1-dimensional (conventional multitrack) or 2-dimensional optical storage using a multi-spot grating) approach, while keeping the read-out temperature in the disk at acceptable levels. In a third implementation a further CBR improvement with roughly a factor 1.5 could be obtained using a PIN-based APD instead of a conventional PDIC detector.

It is possible to use less or more 10 spots, e.g. a 2-spots, or 4-spots grating. The temperature during read-out will increase when less spots are used in combination with the same laser power. However, as long as the temperature during read-out remains below the writing threshold it is possible to use less than 10 spots. The channel bit rate will decrease rapidly when too much spots are used in combination with the same laser power. This will happen when the signal becomes smaller relative to the electronic noise or the laser noise. However, as long as the channel bit rate remains above an acceptable value it is possible to use more spots.

An embodiment of a read-out device according to the present invention comprising a 2-spot grating is shown in FIG. 35. According to this embodiment the read-out device comprises a laser diode 100 for emitting a reading laser beam L0, a 2-spots grating 101 for generating two slightly displaced laser beams L1, L2 from said reading light beam L0, a beam-splitter 102, an objective 103 for focusing the laser beams L1 and L2 on different positions on the record carrier 104 and a servo lens 105 for focusing the reflected laser beams L1′ and L2′ on different position on a detector 106. By use of the two laser beam spots two bits can be read simultaneously from the disk 104.

The application fields of the multi-spots grating are particularly multiple layer and single layer reflective optical disk systems, like CD, DVD and BD.

It should be noted that only the aberration reduction and the resolution enhancement is applicable to the single-layer information carrier. The N-layer (multilayer) optical information carrier contains N different single TC-layers (P1-PN) separated by spacer layers or N different single-stacks (P1-PN), comprising one recording layer (P) and four dielectric layers (I1-I4) for every single-stack, and separated by spacer layers as shown in FIG. 6.

In summary, an even higher reflectivity (10% more) and an enhanced resolution can be found for both the single layer design and the optimized stack design (of FIG. 6). For k≈1.5 and n≈1.0 a reflection up to 30% and up to 55% can be found for the single layer and the optimized stack design, respectively, using thermo- and photochromic materials compared to the maximal achievable reflectivity of ˜20% using an increase of n. The optimization requirements are less strict for both the single layer design and the optimized stack design. By only optimizing k (k≈1.5) without restrictions to n, a reflectivity around 20% or 45% has been found, for the single layer and the optimized stack design, respectively, using thermo- and photochromic materials.

1. An optical information carrier for recording information by means of an optical beam, said optical information carrier comprising:
a substrate layer (S),
a recording layer (P) including a thermochromic material having temperature-dependent optical characteristics or a photochromic material having light-dependent characteristics for selectively improving the sensitivity during recording and/or read-out, and
a cover layer (C), characterized in that said thermochromic or photochromic material has an imaginary part k of the complex refractive index ñ being larger than 0 at elevated temperature or high light intensity, respectively.

2. An optical information carrier as claimed in claim 1, characterized in that said thermochromic or photochromic material has an imaginary part k of the complex refractive index ñ being larger than 0.5, in particular being in the range from 1.0 to 3, at elevated temperature or high light intensity, respectively.

3. An optical information carrier as claimed in claim 2, characterized in that said thermochromic or photochromic material has a refractive index n at ambient temperature or low light intensity, respectively, being matched to the refractive index n of said substrate and a refractive index n at elevated temperature or high light intensity, respectively, being larger than the refractive index n of said substrate, in particular being larger than 1.6, in particular being in the range from 1.6 to 4.

4. An optical information carrier as claimed in claim 1, characterized in that said thermochromic or photochromic material has a refractive index n at ambient and elevated temperature or at low and high light intensity, respectively, being matched to the refractive index n of said substrate.

5. An optical information carrier as claimed in claim 1, characterized in that said thermochromic or photochromic material has a refractive index n at ambient temperature or at low light intensity, respectively, being matched to the refractive index n of said substrate and a refractive index n at elevated temperature or high light intensity, respectively, being smaller than the refractive index n of said substrate, in particular being smaller than 1.6, in particular being in the range from 1.0 to 1.6.

6. An optical information carrier as claimed in claim 1, characterized in that said a recording layer (P) has a thickness in the range from 10 to 200 nm, in particular in the range from 20 to 80 nm.

7. An optical information carrier as claimed in claim 1, further comprising at least one dielectric layer (I) on each side of said recording layer (P).

8. An optical information carrier as claimed in claim 7, comprising two dielectric layers (I1-I4) on each side of said recording layer (P), the dielectric layers (I2, I3) adjacent said recording layer (P) having a refractive index n being smaller than the refractive index n of said thermochromic or photochromic material at elevated temperature or high light intensity, respectively.

9. An optical information carrier as claimed in claim 8, characterized in that the dielectric layers (I1, I4) not adjacent said recording layer (P) have a refractive index n being larger than the refractive index n of said thermochromic or photochromic material at elevated temperature or high light intensity, respectively.

10. An optical information carrier as claimed in claim 8, characterized in that said dielectric layers (I2, I3) adjacent said recording layer (P) essentially comprise SiO₂ and that said dielectric layers (I1, I4) not adjacent said recording layer (P) essentially comprise Si₃N₄.

11. An optical information carrier as claimed in claim 1, comprising two or more recording layers (P1, P2) separated by spacer layers (R).

12. An optical information carrier as claimed in claim 1, characterized in that said recording layer (P) further include as a recording material a phase-change material or a write-once material.

13. Method of determining the thickness of a recording layer (P) of an optical information carrier as claimed in claim 1, comprising the steps of:
selecting a thermochromic or photochromic material having a low initial k value (kᵢₙᵢₜᵢₐₗ) at a first wavelength (λ₁) and a higher k value (kₘₐₓ) at a second wavelength (λ₂) shorter or longer than said first wavelength (λ₁), and having a real part n of the complex refractive index ñ matched to that of substrate layer (S) and/or said cover layer (C),
recording test data,
determining the refractive index mismatch Δn between said thermochromic or photochromic material and said substrate layer (S) and/or said cover layer (C) at essentially said first wavelength (λ₁) after recording said test data,
determining the smallest optimized layer thickness (dₒₚₜ) of said thermochromic or photochromic material by determining the signal-contrast between a written and an unwritten mark,
determining the maximal initial k value (kᵢₙᵢₜᵢₐₗ₋ₘₐₓ) at essentially said first wavelength (λ₁) for said optimized layer thickness (dₒₚₜ) before recording.

14. Method as claimed in claim 13, wherein said maximal initial k value (kᵢₙᵢₜᵢₐₗ₋ₘₐₓ) is determined by
$${k}_{initial - max} = ( - \frac{λ}{4 Π {d}_{opt}} ) ln ( - \frac{0.5 - {T}_{minimal}}{{R}_{LIG}} )$$
where Tₘᵢₙᵢₘₐₗ determines a minimal allowable transmission of a non-addressed recording layer and R_{L/G} determines a groove/land ratio of the recording layer.

15. Method as claimed in claim 13, wherein said first wavelength (λ₁) is essentially 405 nm, wherein said low initial k value (kᵢₙᵢₜᵢₐₗ) is below 0.5 and wherein said higher k value (kₘₐₓ) is above 0.5.

16. Read-out device for reading data from an optical information carrier (104) as claimed in claim 1, comprising:
a light source (100) for emitting a reading light beam (L0),
a multi-spots grating (101) for generating at least two displaced light beams (L1, L2) from said reading light beam (L0),
means (102, 103, 105) for focusing the displaced light beams (L1, L2) on different positions on the information carrier (104) and for focusing reflected light beams (L1′, L2′) on different position on a detector (106), and
a detector (106) for receiving said reflected light beams (L1′, L2′).

17. Read-out device as claimed in claim 16, wherein said multi-spots grating (101) is a 2-spots, 4-spots, 8-spots or 10-spots grating for generating 2, 4, 8 or 10 displaced light beams.
